(19) United States
(12) Patent Application Publication
(10) Pub. No.: US 2016/0357768 A1
(43) Pub. Date: Dec. 8, 2016

(54) EVENT MAPPING SYSTEM

(71) Applicant: FilmL.A., Inc., Los Angeles, CA (US)

(72) Inventors: Jodi Strong, Los Angeles, CA (US); Stephen M. Cheatham, JR., Murrieta, CA (US); Kelly Kinnett, Long Beach, CA (US)

(21) Appl. No.: 15/238,563

(22) Filed: Aug. 16, 2016

Related U.S. Application Data
(63) Continuation-in-part of application No. 12/395,380, filed on Feb. 27, 2009, now abandoned.

(51) Int. Cl. G06F 17/30; G06F 3/0482; G06F 3/0481; H04W 4/02

(52) U.S. Cl. CPC G06F 17/3087; H04W 4/021; G06F 17/30241; G06F 3/0482; G06F 3/04817; G06F 17/30554

(57) ABSTRACT

Computer architecture, software, and security techniques are disclosed relating to an integrated mapping and calendaring system. A map may be generated and rendered that displays event pins or event routes. Event conflicts may be identified based on overlapping geofences. Alerts may be generated in response to detecting conflicts related to location. The conflict alert may be rendered in a map overlay. A calendar may be rendered in association with the map that indicates calendared events depicted in a map overlay.

### COPYRIGHT RIGHTS

A portion of the disclosure of this patent document contains material that is subject to copyright protection. The copyright owner has no objection to the facsimile reproduction by any one of the patent document or the patent disclosure, as it appears in the Patent and Trademark Office patent file or records, but otherwise reserves all copyright rights whatsoever.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### STATEMENT REGARDING FEDERALLY SPONSORED R&D

Not applicable.

### PARTIES OF JOINT RESEARCH AGREEMENT

Not applicable.

### REFERENCE TO SEQUENCE LISTING, TABLE, OR COMPUTER PROGRAM LISTING

Not applicable.

### BACKGROUND OF THE INVENTION

Field of the Invention

The present invention relates to methods and systems for calendars and electronic maps.

Description of the Related Art

Conventional mapping applications may be used to map a location for an event. However, conventional techniques fail to adequately integrate mapping functions and calendaring.

### SUMMARY

Aspects of the disclosure relate to methods and systems for integrating mapping functions with a calendaring application to provide hybrid calendar/map interface. Aspects of the disclosure relate to techniques for reducing page load times by filtering information transmitted to and rendered by an end user device.

Aspects of the disclosure relate to computer architecture, software, and information security techniques for an integrated mapping and calendar application. In an aspect, multiple calendar entries related to a physical area may be identified, and a map may be generated and rendered illustrating the locations in the physical area. The rendered map may further illustrate (e.g., graphically and/or textually using overlays) the event types calendared for the locations. Event routes (e.g., that may include one or more city blocks or a park path) may also be graphically illustrated via the map (e.g., using overlays). Calendar conflicts may be identified with respect to a given location (e.g., in response to receiving a request for a location for a specified day and/or time), and corresponding conflict alerts may be transmitted to one or more destination addresses (e.g., mobile phone addresses, email addresses, shot message addresses), via an application (e.g., a mobile device app), and/or via a webpage.

An aspect of the disclosure relates to the generation and rendering of a map that displays event pins (or other event indicator) or event routes. Event conflicts may be identified based on overlapping geofences. Alerts may be generated in response to detecting conflicts related to location. The conflict alert may be rendered in a map overlay. A calendar may be rendered in association with the map that indicates calendared events depicted in a map overlay.

An aspect of the disclosure relates to a generated hybrid calendar/map user interface indicating calendar entries for a given day, month, or other time period and a map of the location of calendared events. The integrated calendar/map display may be provided via a webpage, a dedicated application (e.g., a mobile device app), or otherwise. Thus, disclosed herein is an enhancement over conventional techniques that produces a dual-source or multi-source integrated hybrid calendar/map display.

An aspect of the disclosure relates to a location-access control system, comprising: a computing device; a network interface; non-transitory memory configured to store instructions that when executed by the computing device, are configured to cause the location-access system to perform operations comprising: generate an interface configured to receive an identification of a desired location; transmit to a remote terminal, using the network interface, the interface configured to receive an identification of a desired location; receive over the network using the network interface, via the interface configured to receive an identification of a desired location, an identification of the desired location, the desired location associated with a latitude and longitude; generate an interface configured to receive an identification of an event type to be associated with the desired location and corresponding date information; transmit to the remote terminal, using the network interface, an interface configured to receive an identification of an event type to be associated with the desired location and corresponding date information; receive over the network using the network interface, via the interface configured to receive an identification of an event type to be associated with the desired location and corresponding date information, the identification of the event type and the corresponding date information; generate requests for location-related event data for a plurality of remote data stores for at least the identified location and the corresponding date information; transmit over the network, using the network interface, the generated requests for location-related event data to the plurality of remote data stores; receive and aggregate location-related event data from the plurality of remote data stores, the location-related event data comprising identifications of event types for a plurality of locations and corresponding location identifiers; generate a request for a map from a remote mapping system using a map application programming interface, the request including a location specification, a zoom specification, and an overlay specification, the overlay specification comprising a specification for event indicators at corresponding event locations; enable map tiles, generated by the remote mapping system in response to the map request, to be assembled and displayed on the remote terminal as map via a first user interface, the map including event indicators indicating event locations.

An aspect of the disclosure relates to a system, comprising: a computing device; a network interface; non-transitory memory configured to store instructions that when executed by the computing device, are configured to cause the location-access system to perform operations comprising: generate at least a first interface configured to: receive an identification of a desired location, receive an identification of an event type to be associated with the desired location and corresponding date information; transmit to a remote terminal, using the network interface, the first interface configured to receive an identification of a desired location and an identification of an event type to be associated with the desired location and corresponding date information; receive over the network using the network interface, via the first interface configured to receive an identification of a desired location and an identification of an event type to be associated with the desired location and corresponding date information, the identification of a desired location and the identification of an event type to be associated with the desired location and corresponding date information; generate requests for location-related event data for a plurality of remote data stores for at least the identified location and the corresponding date information; transmit over the network, using the network interface, the generated requests for location-related event data to the plurality of remote data stores; receive location-related event data from the plurality of remote data stores, the location-related event data comprising identifications of event types for a plurality of locations and corresponding location identifiers; generate a request for a map from a remote mapping system using a map application programming interface, the request including a location specification and an overlay specification, the overlay specification comprising a specification for event indicators at corresponding event locations; enable a map to be displayed on the remote terminal via a second user interface, the map including event indicators indicating event locations.

An aspect of the disclosure relates to a computer-implemented method, comprising: generating, by a computer system comprising at least a computing device, at least a first interface configured to: receive an identification of a desired location, receive an identification of an event type to be associated with the desired location and corresponding date information; transmitting to a remote terminal, using a network interface, the first interface configured to receive an identification of a desired location and an identification of an event type to be associated with the desired location and corresponding date information; receiving over the network using the network interface, via the first interface configured to receive an identification of a desired location and an identification of an event type to be associated with the desired location and corresponding date information, the identification of a desired location and the identification of an event type to be associated with the desired location and corresponding date information; generating requests for location-related event data for a plurality of remote data stores for at least the identified location and the corresponding date information; transmitting over the network, using the network interface, the generated requests for location-related event data to the plurality of remote data stores; receiving location-related event data from the plurality of remote data stores, the location-related event data comprising identifications of event types for a plurality of locations and corresponding location identifiers; generating a request for a map from a remote mapping system using a map application programming interface, the request including a location specification and an overlay specification, the overlay specification comprising a specification for event indicators at corresponding event locations; causing, at least in part, a map to be displayed on the remote terminal via a second user interface, the map including event indicators indicating event locations.

### BRIEF DESCRIPTION OF THE DRAWINGS

Specific embodiments will now be described with reference to the drawings, which are intended to illustrate and not limit various features of the inventions. These embodiments may be combined, other embodiments may be utilized, and structural changes may be made without departing from the spirit or scope of the present invention.

FIG. 1A illustrates a first example computing system operating environment.

FIG. 1B illustrates an example map generation process.

FIGS. 1C-1L illustrate example user interfaces.

FIG. 1M illustrates a second example computing system operating environment.

FIG. 2 illustrates an example document generation process.

FIG. 3 illustrates an example conflict identification and resolution process.

FIGS. 4-11 illustrate example user interfaces.

FIGS. 12A-C illustrate an example permit.

### DETAILED DESCRIPTION

Aspects of the disclosure relate to methods and systems for integrating mapping functions with a calendaring application to provide hybrid calendar/map interface. Aspects of the disclosure relate to techniques for reducing page load times.

Aspects of the disclosure relate to computer architecture, software, and information security techniques for an integrated mapping and calendar application. In an aspect, multiple calendar entries related to a physical area may be identified, and a map may be generated and rendered illustrating the locations in the physical area. The rendered map may further illustrate (e.g., graphically and/or textually using overlays) the event types calendared for the locations. Event routes (e.g., that may include one or more city blocks or a park path) may also be graphically illustrated via the map (e.g., using overlays). Calendar conflicts may be identified with respect to a given location (e.g., in response to receiving a request for a location for a specified day and/or time), and corresponding conflict alerts may be transmitted to one or more destination addresses (e.g., mobile phone addresses, email addresses, short message addresses), via an application (e.g., a mobile device app), and/or via a webpage.

An aspect of the disclosure relates to the generation and rendering of a map that displays event pins (or other event indicator) or event routes. Event conflicts may be identified based on overlapping geofences. Alerts may be generated in response to detecting conflicts related to location. The conflict alert may be rendered in a map overlay. A calendar may be rendered in association with the map that indicates calendared events depicted in a map overlay.

A hybrid calendar/map user interface may be generated indicating calendar entries for a given day, month, or other time period and a map of the location of calendared events. The integrated calendar/map display may be provided via a webpage, a dedicated application (e.g., a mobile device app), or otherwise. Thus, disclosed herein is an enhancement over conventional techniques that produces a dual-source or multi-source integrated hybrid calendar/map display.

Optionally, as will be discussed in greater detail herein, filtering services may be provided to control the number and/or types of calendar databases accessed and the types of events displayed via the hybrid calendar/map interface. This may reduce the amount of network bandwidth utilized by the server hosting the integrated mapping and calendar application needed to access the data used to generate the hybrid calendar/map interface. Further, the utilization of filters may reduce the amount of user device computing power utilized and the amount of memory needed to render the hybrid calendar/map interface, and may reduce page load time for the hybrid calendar/map interface.

By way of illustration, a location reservation user interface may be transmitted over a network by calendar and mapping application for display on a user device browser (or the user interface may be displayed by a dedicated application). The user device may be a mobile or a non-mobile device. For example, the user device may be configured with a variety of wireless interfaces, such as CDMA, GSM, Bluetooth®, WiFi (e.g., 802.11 compliant WiFi), and/or other wireless interfaces. The user device may be equipped with wired interfaces, such as Lighting ports, USB ports, Ethernet ports, or other port types. The user device may be equipped with antennas, cameras, a touch screen, a microphone, a speaker, accelerometer, tilt detector device, and/or a haptic feedback device.

The location reservation user interface may include controls (e.g., buttons, fields, menus, voice input, etc.) via which a user can specify a location jurisdiction, a location name, a location type, a location address, and/or an event type for a location reservation request. An example of an event type may include filming for a feature film, filming for a made for television movie, filming for a documentary, filming for a situation comedy, filming for a dramatic television show, filming for a commercial, filming for a music video, filming for a corporate video, still photography, or other example event types disclosed herein. The location reservation user interface may further enable the user to specify a date or dates (e.g., month, day, and year) and a time period (or periods) for the location request.

The location request may be transmitted from the user device over a wired and/or wireless network (e.g., the Internet) to a server hosting a calendar and mapping application. The requested location may be associated with a corresponding latitude coordinate and longitude coordinate, a geographical grid, and/or a geofence. The grid or geofence may define a perimeter about the first location. The perimeter may be in the form of a square or rectangle, or the perimeter may be in the form of a non-square or rectangular polygon, or the perimeter may be in the form of a circle, ellipse, or a combination of curved and straight line segments. The perimeter may be an open or closed perimeter. The requested location may be associated with one or more location types. For example, a location type may be transportation, airport, train station, bus station, forest, a marina, park, forest, school, beach, harbor, municipal/governmental facility, port, residential street, commercial street, or the like. By way of illustration, a location may be a park, and the park may include a forest.

Existing calendar entries may be accessed for at least the requested location and the requested date(s) over a network from one or more calendar data stores (e.g. using an API). The calendar entries may be imported and converted, if need be. For example, if the accessed calendar entries are in a non-ICS format, the application may convert the calendar to an ICS format for utilization by the application, although other calendar record formats may be used. By way of illustration, different entities may maintain different calendar records for the same physical location using different formats. By way of further illustration, different entities may maintain different calendar records for different event types, where one entity may maintain calendar records related to street maintenance or construction in an ICS format, another entity may maintain calendar records related to parades using a proprietary format, and the system hosting the mapping and calendar application may maintain calendar records related to filming events (e.g., using still, video, or movie film capture devices). By accessing event calendars from entities responsible for the corresponding events, the aggregated calendar data is more likely to be accurate and up to date.

Optionally, event data may be updated using distributed sensors (e.g., water sensors that detect water main leaks, stress sensors and/or vibration sensors that detect earthquakes, smoke or heat sensors that detect brush or forest fires, etc.). For example, if a forest fire is detected, that corresponding location may be identified as being reserved until conditions are safe.

A given accessed calendared location reservation may be associated with an event type. For example, a calendar entry may indicate whether the reservation is for filming (using an image capture device), construction, a sporting event, a closure, a parade, a first amendment demonstration, or the like.

The mapping and calendar application may provide for display a calendar user interface that may include the current location reservations for the requested first location. The user interface may display textually and/or graphically (e.g., via icons) a jurisdiction identifier, a location name, a location type, and for events scheduled for the first location, the event types. The mapping and calendar application may access mapping information via an application programming interface for the location and/or the jurisdiction in which the location is situated. For example, the mapping and calendar application may access an application programming interface (API) from a first website or other source or the mapping and calendar application have the API integrated therein. The API may be used to pass information to a mapping application hosted by a remote server and to receive information from the remote sever.

For example, the mapping and calendar application may transmit latitude and longitude information and/or a location name (or address) corresponding to the desired center of the map via the API to the remote server. The mapping and calendar application may transmit a desired zoom factor or percentage via the API to the remote server. Optionally, the mapping and calendar application may transmit an identification of a desired map type via the API to the remote server. For example, the map type may be a terrain map (e.g., illustrating elevations, streams, rivers, mountains, etc.), a two or three dimensional road map (e.g., with street names, city names, neighborhood names, etc.), a photographic map (e.g., comprised of images captured from an airborne or satellite borne camera), or a hybrid map (combining a hybrid map with a road map).

The mapping and calendar application may create an element to hold the map and may use cascading style sheets (CSS) to size the element (e.g., by defining a width and height in pixels) and hence the map that will inherit the container width and height. The mapping and calendar application may create a map container. The mapping and calendar application may add an event listener (e.g., a DOM (Document Object Module) listener) to execute an initialize function with the map is loaded. Optionally, the map API may be loaded asynchronously, on demand.

The mapping and calendar application may add one or more overlays to the map via the API. The overlays may be used to identify specific locations, identify activity routes, indicate activity types, provide location names, indicate conflicts between events at a location or locations, identify points of interest, operating hours, etc. For example, the overlay(s) may include one or more of the following:
a pin or marker to identify a specific point/location on the map. The marker may optionally be in the form of an icon and may be associated with text;
a polyline (e.g., a set of straight lines, which may form a path or illustrate a route, specified by the mapping and calendar application via a set of corresponding latitude and longitude coordinates or corresponding location names or addresses);
a polygon (a set of straight lines that form a closed shape (which may be used to illustrate boundaries of an event), specified by the mapping and calendar application via a set of corresponding latitude and longitude coordinates or corresponding location names or addresses);
a circle or ellipse (e.g., which may be used to illustrate boundaries of an event, where the mapping and calendar application specifies a latitude coordinate and a longitude coordinate or corresponding location name or address for the circle center, and a radius (e.g., in feet or meters));
text (e.g., in a popup balloon), which may be used to provide a location name or to describe or name an event;
controls (e.g., links) via which the user can provide feedback or other user input.

Optionally, the mapping and calendar application may specify one or more of the following: an overlay color, line stroke weight (e.g., in pixels), opacity of line stroke, fill color, fill opacity, and whether the overlay may be edited by a user. The foregoing may be utilized in specifying a location perimeter or a route.

The mapping and calendar application may add one or more animations to a map overlay via the API (e.g., to indicate an activity type, a location type, or to indicate availability status; such as a movie camera with spinning reels for a filming event, a swimming person for a beach location, or a flashing stop light to indicate a conflict).

Thus, the mapping and calendar application may provide for display on the user terminal detailed calendar entry data for at least the requested location on the specified date, and a map depicting the location and a surrounding area (e.g., the jurisdiction in which the location is situated) and other locations within the adjacent area that have scheduled activities. In addition, the map may include overlays (e.g., pins, icons, etc.) indicating activity types. Optionally, in accessing mapping services via the API, the mapping and calendar application may specify the desired center of the map and a zoom level that corresponds to the location that is the subject of a calendar entry/reservation request and a specified radius or grid about the location. Optionally, in accessing mapping services via the API, the mapping and calendar application may specify the desired center of the map and a zoom level that corresponds to the location that is the subject of a calendar entry/reservation request and a jurisdiction of the location. The map may be configured to have the shape of a square or rectangle in order to better corresponding to the shape of a browser window. The map may be displayed with a zoom control enabling the user to zoom in or out. User controls may be provided that enable the user to specify a desired map type (e.g., street, photographic, or hybrid). Optionally, the map may indicate (e.g., by highlighting with a visual pin, border, animation, or other highlighting technique), if a special shooting condition exists at a location. If for example, if a location is in a fire hazard zone, a border may be displayed around the zone with a color or in association with and an icon or animation (e.g., an animated fire) indicating a fire zone. Similarly, if the location is in a district where certain event types are not permitted, a border may be displayed around the district with a color or in association with and an icon (e.g., an icon corresponding to the prohibited event, such as a movie camera for filming, with a line through it) or animation indicating that the event type is not permitted. The map may also be generated to indicate one-way streets, parking availability, road work, road closures, accidents, and/or other items of interest.

Filtering services may optionally be provided to control the number and/or types of calendar databases accessed and the types of events to be displayed via the hybrid calendar/map interface. For example, a control may be provided via which a user can specify which event types are to be displayed by the hybrid calendar/map interface. By way of illustration, the control may enable the user to cause the hybrid calendar/map interface to display only one of the following event types are any subset of the following event types: filming, construction, a sporting event, a closure, a parade, a first amendment demonstration. The mapping and calendar application may, in response, only access calendar data stores that store calendar entries for the specified location for the selected event types.

If a location reservation request is received at the mapping and calendar application for a specified location and time, the mapping and calendar application may determine if the location is already reserved for that date and time. If the mapping and calendar application determines that the location is already reserved for that date and time, the calendar may generate one or more alerts. The alerts may be transmitted to one or more destinations via one or more communication channels (e.g., email, web page, instant message, short and/or multimedia messaging service (SMS/MMS) message, fax, hard copy correspondence, phone, or otherwise) according to one or more algorithms, rules, and/or distribution lists. The conflict may also be displayed via the hybrid calendar/map interface (e.g., by emphasizing the conflicted location via an icon, color, and/or perimeter).

In certain instances, a request may be received at the mapping and calendar application for a specified date for a location that includes a route or a custom perimeter specified by the requester. The requested location may be associated with a first geofence that defines the location perimeter. Optionally, the first geofence may be compared with geofences of other locations reserved for that same date to determine if the first geofence overlaps with other geofences (e.g., if any longitude/latitude coordinates associated with the first geofence fall within longitude/latitude coordinates of one or more other reserved location geofences). If the first geofence overlaps with one or more of the other geofences, a conflict determination may be made and conflict alerts may be transmitted as similarly discussed above.

Optionally, requests to reserve a location are transmitted to systems (or system terminals) of a plurality of different entities prior to acceptance of the reservation. Example systems may include the systems of an entity that administrates the location, a police department system, a fire department system, or other example systems disclosed herein. For example, if a request is received for a filming event at a park, the request for approval may be sent to a system of a manager for the specific park, to a system of the overall administrator of parks for the jurisdiction, to the fire department system, and to the police department system. If one or more of the entities do not approve the request, the request may be denied, the request will not be calendared by the system, and the denial may be transmitted to the requester, as similarly described elsewhere herein.

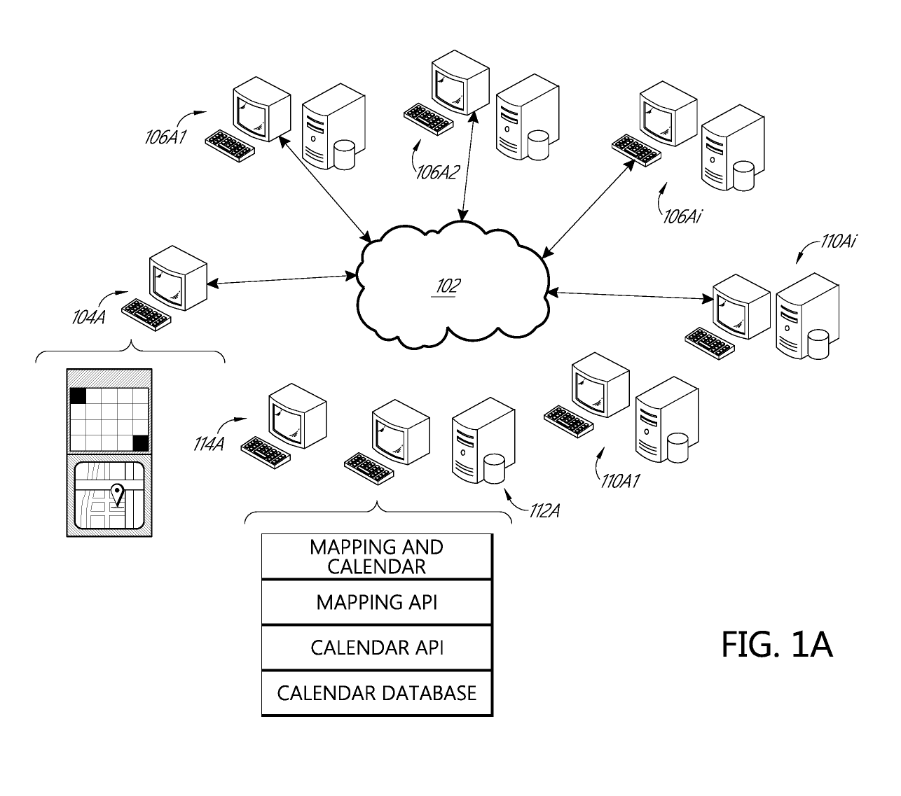

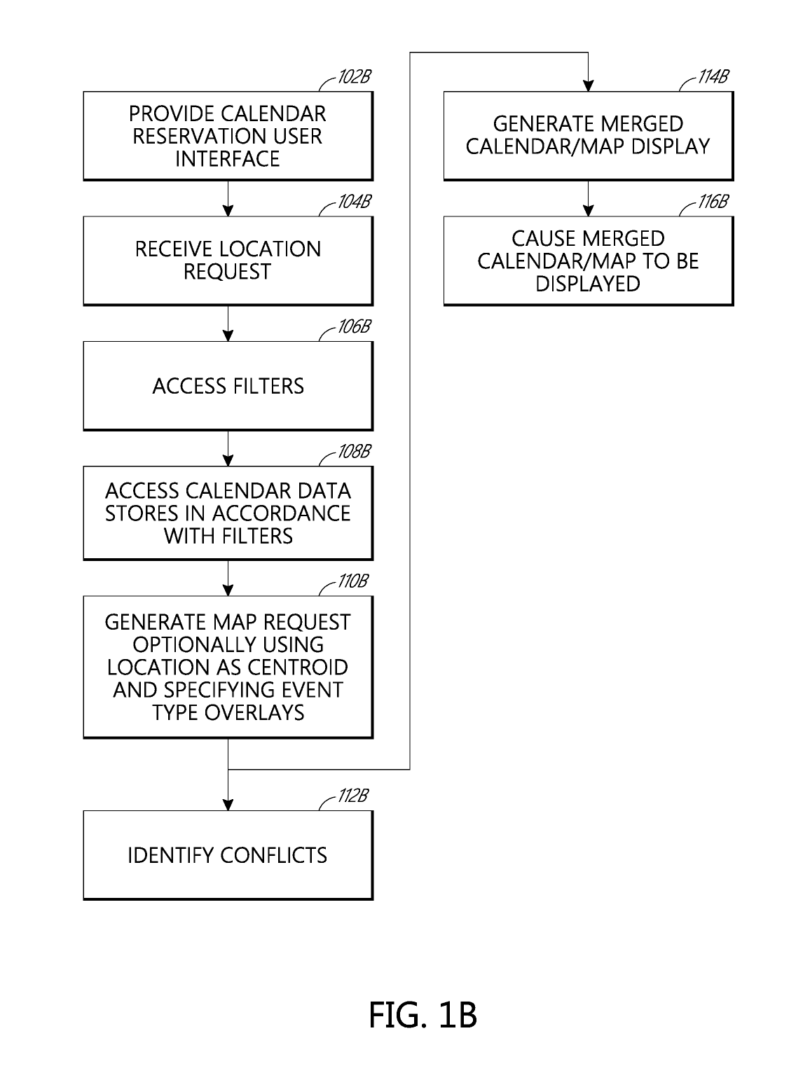

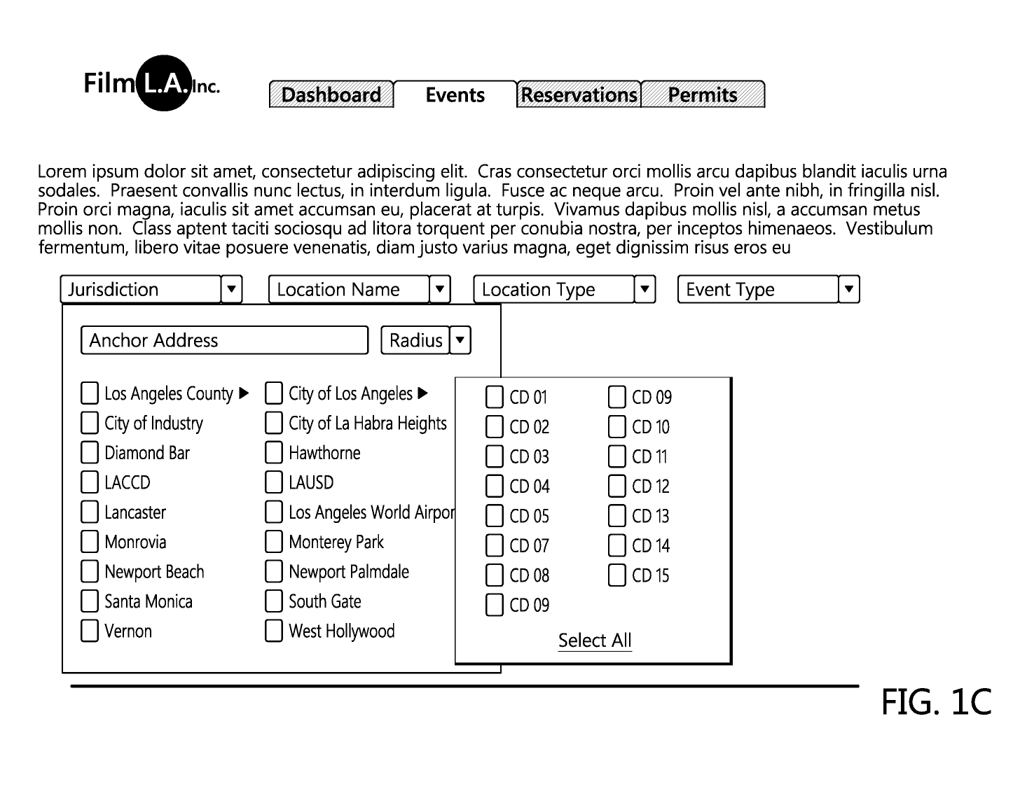

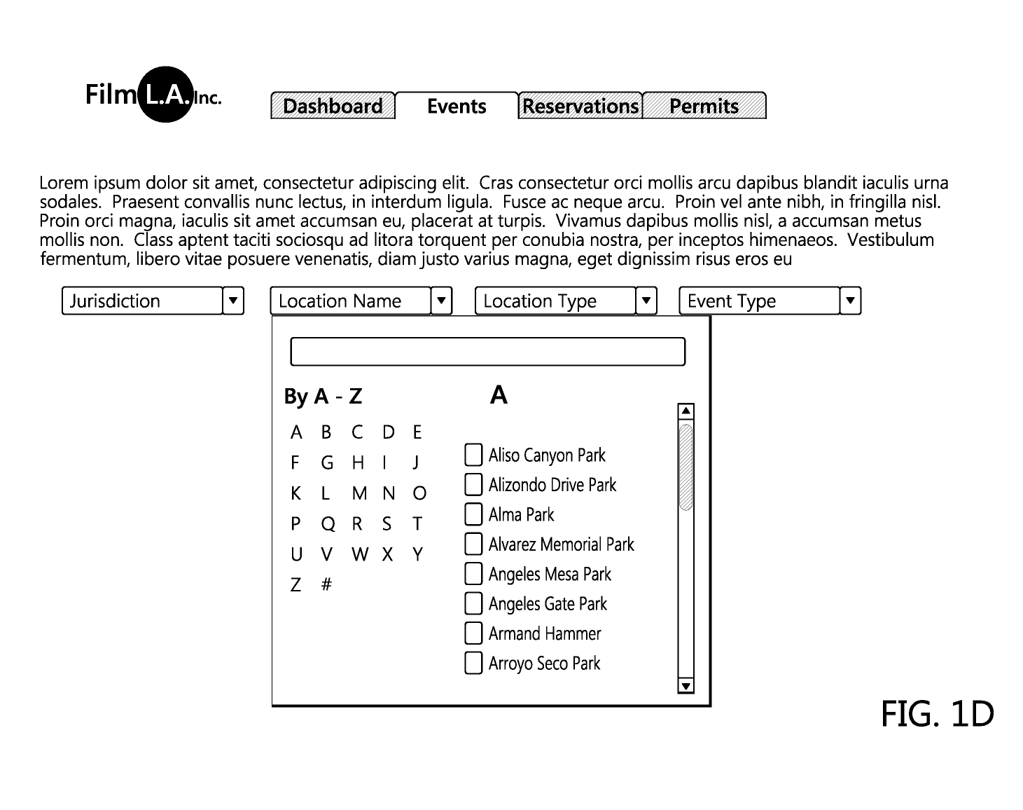

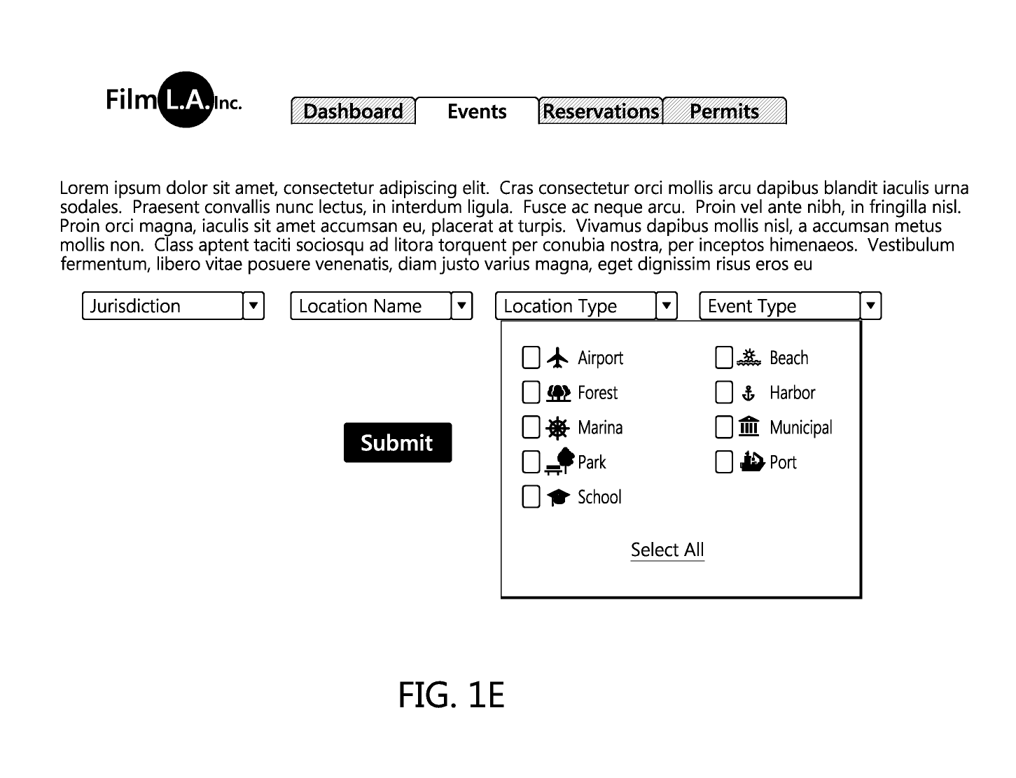

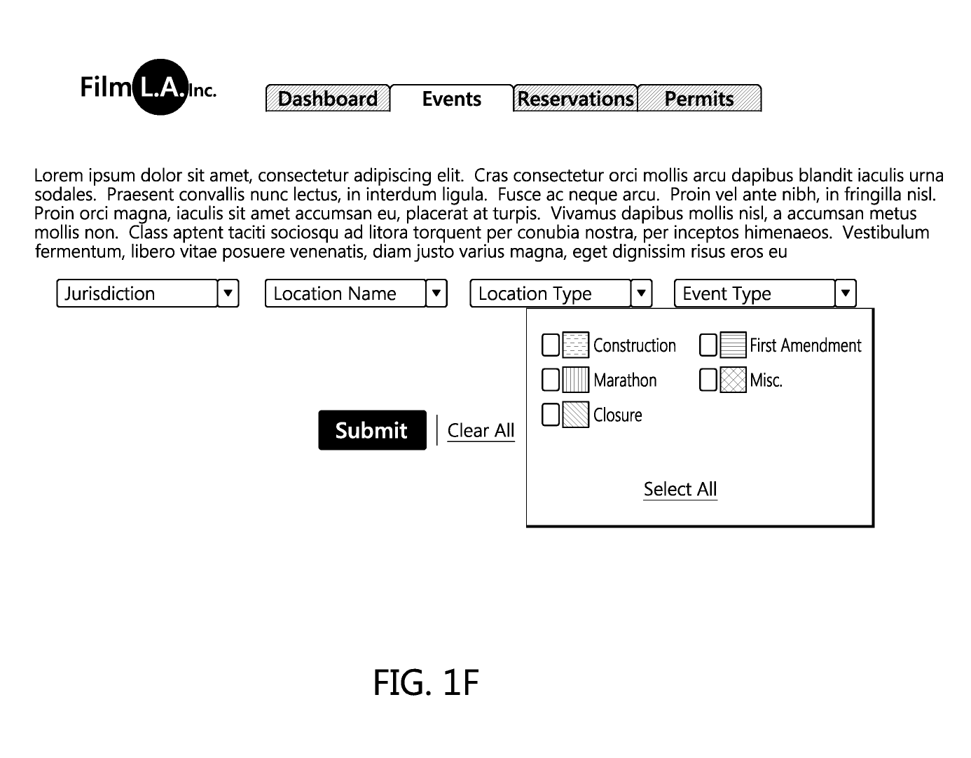

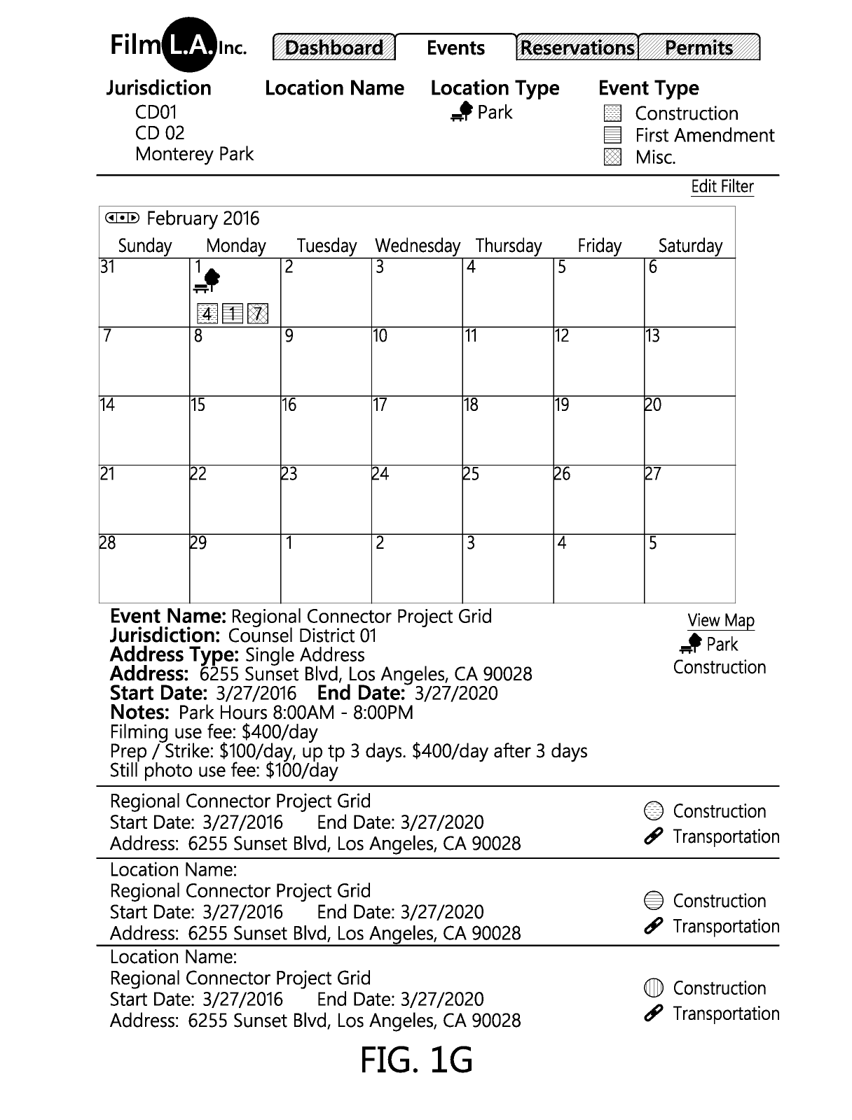

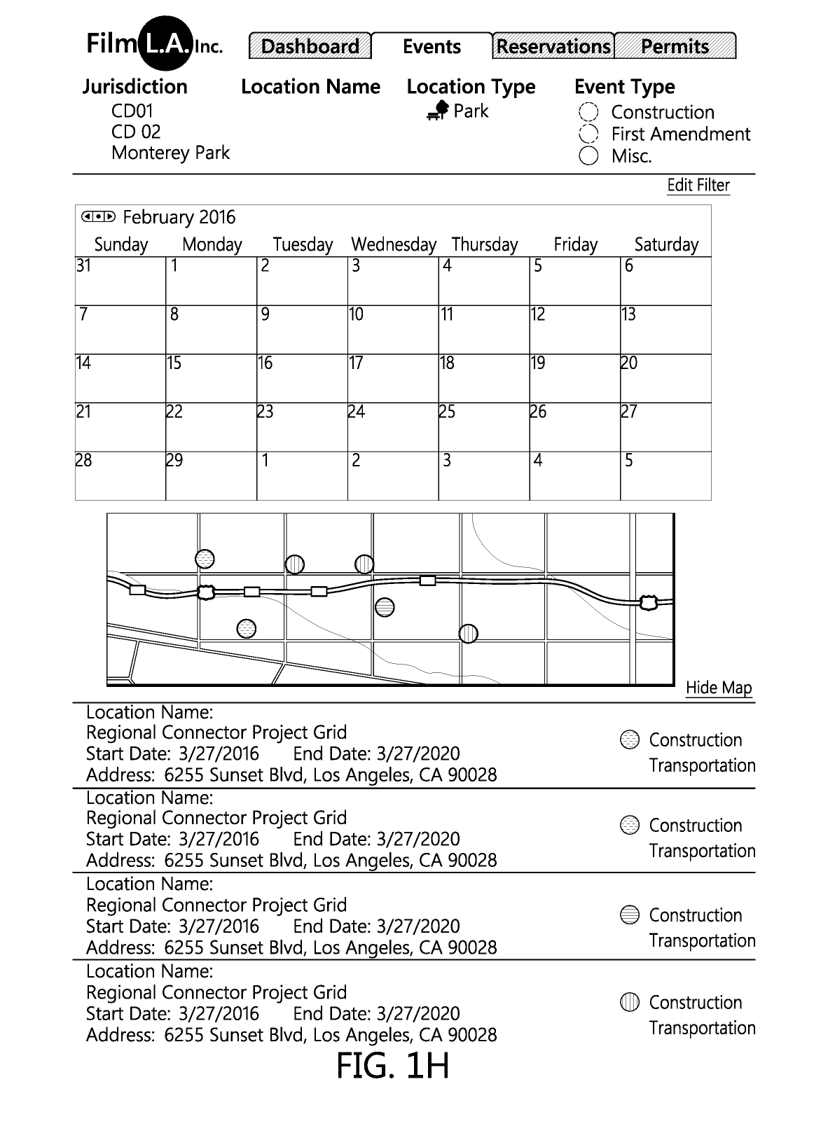

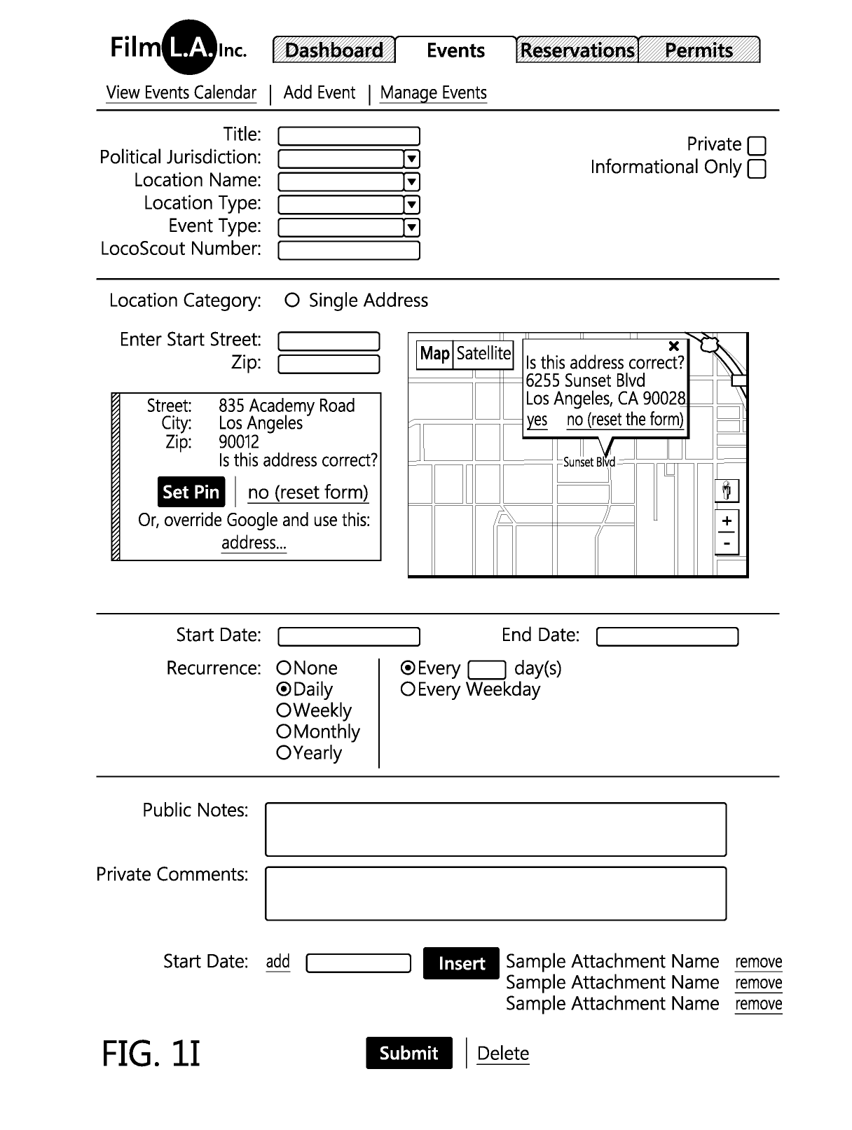

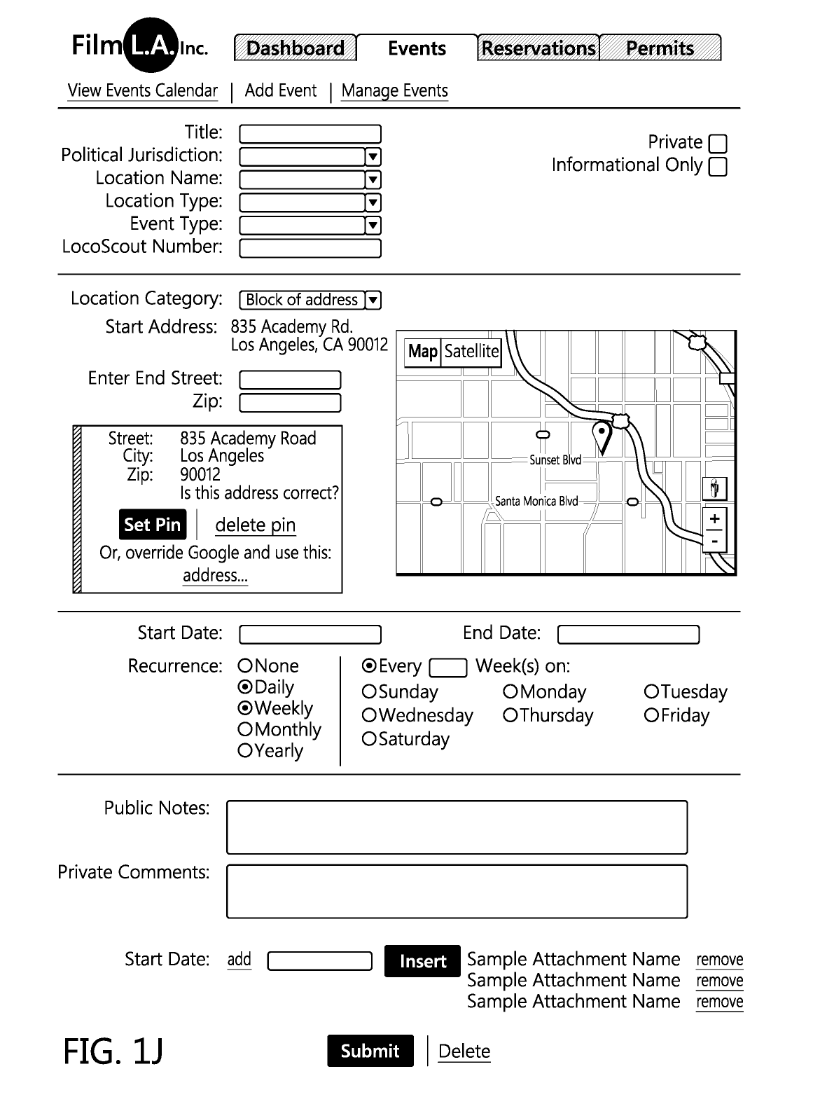

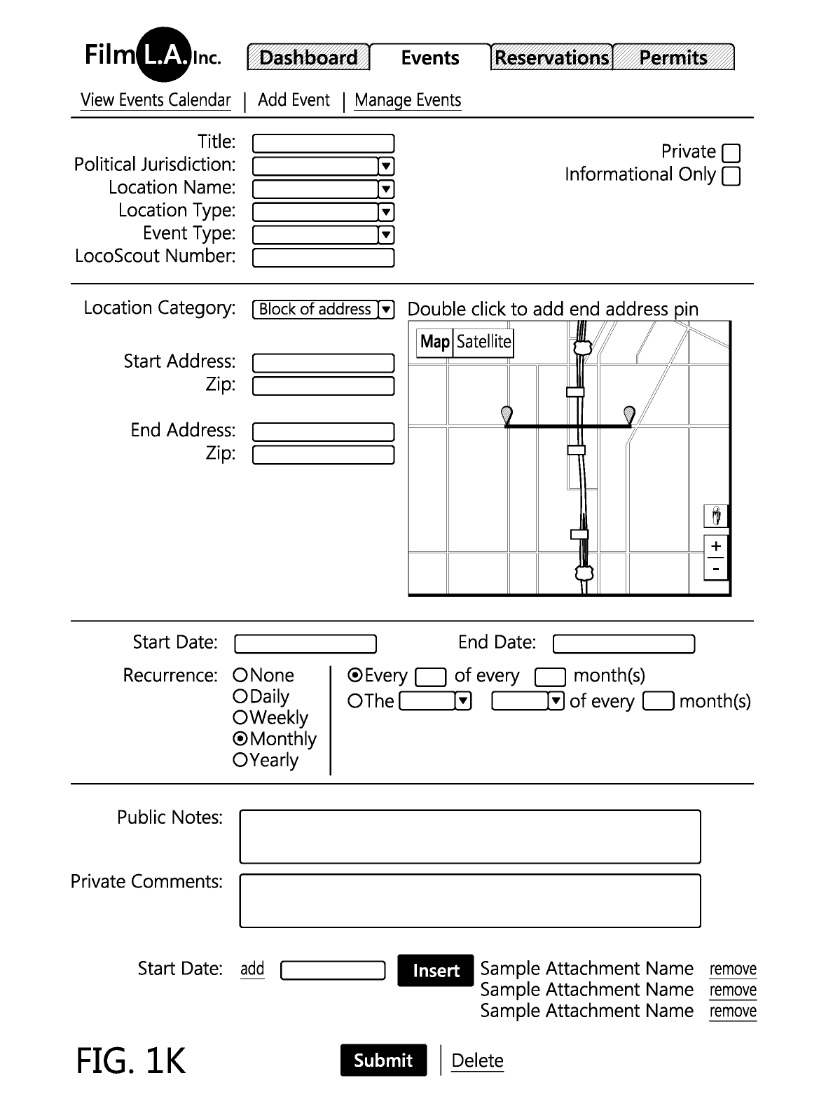

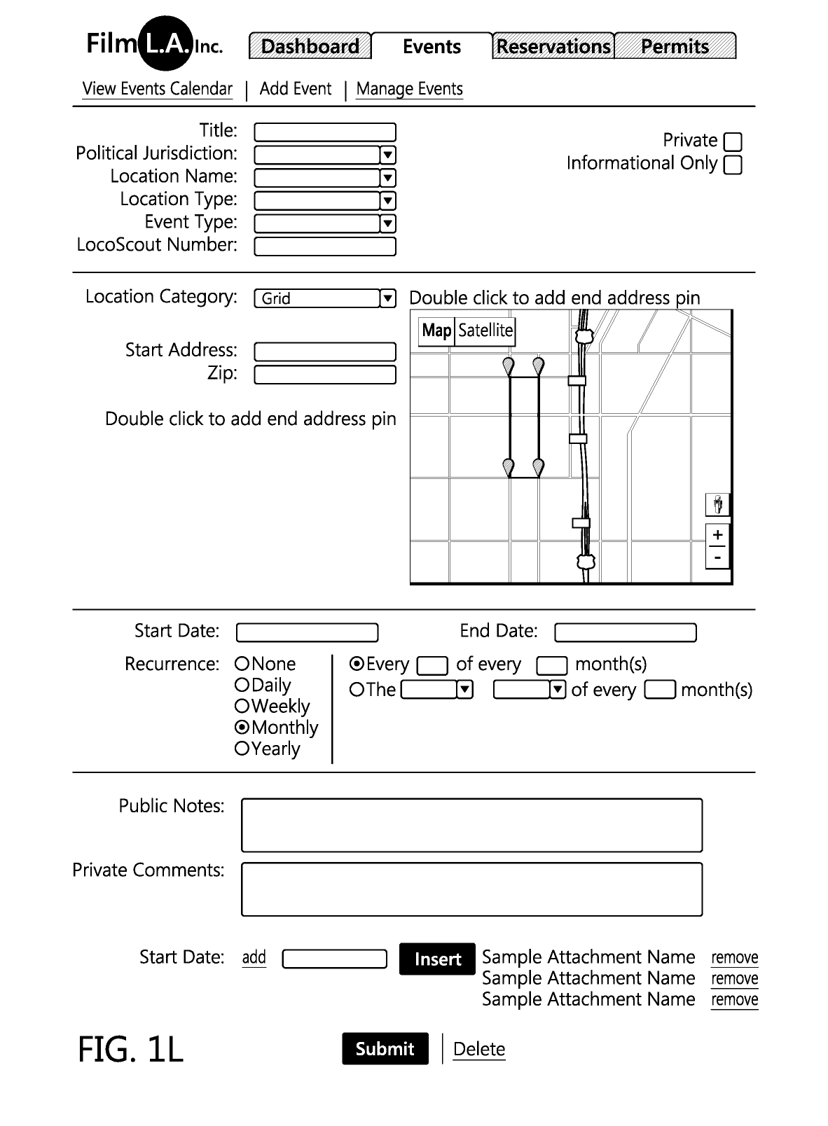

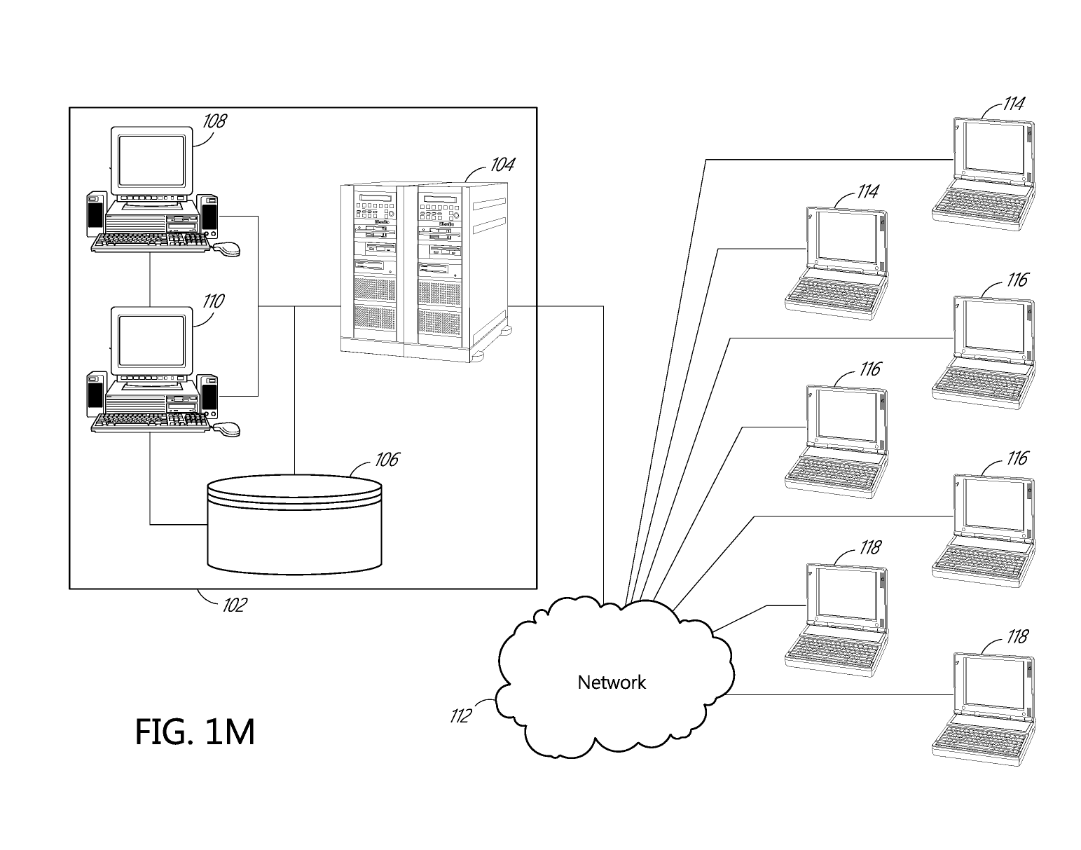

Referring now to example FIG. 1A, an exemplary computing system operating environment is illustrated that may be used in conjunction with mapping and calendaring processes. A calendaring and mapping system 112A may include a web server hosting a mapping and calendar application, a mapping API for accessing maps from a mapping system, a calendar API for accessing calendar records from one or more other calendar systems, and a calendar database that stores calendar records. The calendaring and mapping system 112A may optionally include or be networked to a permit computer-based process system, such as that described elsewhere herein. The calendaring and mapping system 112A may include one or more network interfaces, displays, user input devices (e.g., keyboard, multi-touch screen, microphone, mouse, touch pad, etc.), and/or printers. The calendaring and mapping system 112A may be a cloud based system comprising multiple servers optionally at multiple geographically separate locations.

To enhance security, optionally the calendaring and mapping system 112A may maintain calendar records in a database separate from the system web server that serves and manages user interfaces. For example, the database may be stored on a separate disk system or on a separate disk partition from the web server. By way of further example, the mapping and calendar web application and associated website files and scripts may be stored on a separate drive or a separate partition than that of the operating system and other system files to prevent hackers from accessing the root directory and obtaining privileges to access all system files and data. The calendar records database may be located behind a firewall that monitors and controls incoming and outgoing network traffic based on security rules (e.g., predetermined security rules). The calendar records database may be encrypted to further enhance security and discourage tampering and unauthorized access. The system may also utilize web application firewalls. The firewalls may perform packet filtering. The firewalls may inspect packets for improper (e.g., viruses, Trojan horses, etc.) or suspicious content, and can restrict or drop such packets to prevent the spread of such improper content. The firewalls may comprise an application firewall that determines whether a process should accept an attempted connection. Optionally, web server log files may be stored in segregated memory to prevent tampering.

As similarly discussed elsewhere herein, the calendaring and mapping system 112A may store calendar records related to filming permits and may access over a network 102 (e.g., the Internet, an intranet, or other network) calendar records from other calendaring systems 110A¹ . . . 110Aⁱ via one or more calendar APIs. The calendar records may be in ICS format or other format. The other calendaring systems 110A¹ . . . 110Aⁱ may store calendar records for specific event types (e.g., construction, sporting events, etc.) and/or for specific locations or specific location types (e.g., parks, municipal buildings, sporting venues, a specific park, a specific municipal building (e.g., city hall), a specific sporting venue (e.g., a specific stadium), etc.). The calendaring and mapping system 112A may integrate some or all of the accessed calendar records into a unified calendar to provide a more comprehensive and up to date view of location calendars, and to reduce or eliminate the need for the calendaring systems 110A¹ . . . 110Aⁱ to provide corresponding web services directly to users, thereby reducing the network and computer utilization of the calendaring systems 110A¹ . . . 110Aⁱ.

The calendaring and mapping system 112A may communicate over the network 102 with one or more mapping systems 114A via an API as similarly discussed elsewhere herein. The mapping system 114A may include a map content server and a map database (e.g., storing street level data (e.g., the location and names of streets, street addresses, etc.), geographical data (e.g., waterways, forests, mountains), municipal borders and borders of sub-regions, latitude data, longitude data, elevation data, land use data, etc.) and may generate and serve map tiles which then may be assembled, rendered, and displayed on a user terminal as a single digital map. The map database may store photographs of locations and corresponding latitude, longitude, and elevation data which comprising corresponding global positioning satellite (GPS) data, or the data may be from other sources. The photographs may be used in rendering photographic maps in the hybrid display or in overlays (e.g., a photograph of a location may be displayed in a map overlay in association with an event indicator at the mapped location).

The calendaring and mapping system 112A may communicate over the network 102 with one or more user terminals 104A (e.g., tablet computers, laptop computers, smart phones, other mobile devices, desktop computers, networked televisions, game consoles, etc., having wired and/or wireless network interfaces). The various user interfaces disclosed herein may optionally be transmitted by the calendaring and mapping system 112A and/or the mapping system 114A to the user terminal 104A, and the calendaring and mapping system 112A and/or the mapping system 114A may receive data and/or instructions from the user terminal 104A. Optionally, some or all the user interfaces may be provided via a dedicated application executing on the user device instead of or in addition to by the calendaring and mapping system 112A.

FIG. 1B illustrates an example process that may be used in conjunction with other processes described herein (e.g., the permit processes disclosed herein). At block 102B, a system (e.g., the calendaring and mapping system 112A) may serve a location request user interface to a user device, optionally using a Secure Sockets Layer protocol, to provide secure, encrypted communication. The user interface may enable the user to specify (e.g., via text fields and/or via menus) a jurisdiction, location name, location type, and/or an event type that the user wants to conduct at the desired location. The user interface may enable the user to specify one or more dates and times for which the location is desired for the specified event type. Example location request user interfaces are illustrated in FIGS. 1C-1F. The user interfaces may be provided in the form of webpages transmitted to, and displayed by a browser on a user device, or the user interfaces may be provided by a dedicated application hosted and executing on a user device.

With reference to FIG. 1C, a menu may be provided in response to a user selecting a jurisdiction control that lists eligible jurisdictions at a relatively higher level (e.g., at a city/municipality level) and another menu may be provided that enables the user to further refine the jurisdiction to a portion/subset of the jurisdiction (e.g., one or more county or council districts). Optionally, the jurisdiction menu may be a waterfall menu, wherein in response to the user selecting a city/municipality, a sub-menu is generated and presented that only includes subsets (e.g., county or council districts) of the selected city/municipality. This technique reduces the amount of display space that would be otherwise needed to display all the subsets of all the eligible jurisdictions, reduces the amount of network bandwidth that would be needed to transmit a menu of all the subsets of all the eligible jurisdictions, and reduces page load time. The higher level jurisdiction menu and the jurisdiction subset menu may optionally be presented at the same time. The location request user interface may optionally include an anchor address field configured to receive an anchor address for the desired location and may include a radius field (which may be in the form of a menu) that enables the user to specify a radius (e.g., in feet, yards, miles, meters, kilometers, etc.) about the anchor address that the user would like to reserve.

With reference to FIG. 1D, the location request user interface may present a menu of location names in response to the user selecting a location name control. The location names may be organized alphabetically. The location names menu may be generated so that the menu only includes the names of locations in the specified jurisdiction subset. This technique reduces the amount of display space that would be otherwise needed to display all the location names in all the jurisdictions, reduces the amount of network bandwidth that would be needed to transmit a menu of all the location names in all the jurisdictions, and reduces page load time. A text field may be provided via which the user can enter a location name, and in response to receive the entered location name, the system will search for and identify matching and/or approximate matching location names, and return the identified location names for display on the user device. A control may be provided via which the user can select a location name from the search results.

With reference to FIGS. 1E and 1F, the location request user interface may present a menu of event types in response to the user selecting an event type control. The event types may be organized alphabetically or according to category. Optionally, the listed event types may be displayed textually and with an associated icon and/or color. Optionally, the associated icons and/or colors displayed via the event types menu may also be used to identify the same event types in a calendar user interface and/or in a map user interface to provide enhanced recognition. The event types menu may be generated so that the menu only includes event types that are available in the specified location. For example, if the location is a desert, the forest, marina, beach, harbor, and port event types may not be listed. This technique reduces the amount of display space that would be otherwise needed to display all the event types, reduces the amount of network bandwidth that would be needed to transmit a menu of all the event types, and reduces page load time.

Referring again to FIG. 1B, at block 104B, the location request is received at the system. The location request may include a jurisdiction, a location name, a location type, and/or an event type, and may include date or dates and times for the event. At block 106B, filters are optionally accessed. The filters may have been set by the user submitting the location request via one or more filter controls presented via a user interface, or the filters may be set by a system operator, or the system may automatically set the filters based in whole or in part on the submitted location request. The filter may specify specific event types for which location utilization information is desired. For example, the filter may specify that information is desired only for construction and filming events. The filter may also specify a date range for which location event data is desired. For example, the date range may be a single date, a month, or other range of dates. The use of such a filter may reduce the amount of data that is requested and transmitted over the network and may reduce data processing time. For example, calendar data requests may be limited to those remote systems that may have calendar data that meet the filter conditions.

At block 108B, a request for calendar data within the specified date range or within a default date range (e.g., a month, two months, or other default date range) for the requested location, in accordance with the filter controls (if any) is generated and transmitted to one or more calendar data store servers. The request may be transmitted to the calendar data stores (e.g., over a network) using a calendar API. The corresponding calendar records may be returned by the calendar data store servers. The returned calendar records may optionally be converted to a common format (e.g., ICS format) if needed.

At block 110B, a map request is generated. The map request may be generated using a map API. The request may include the specified location (e.g., in the form of the user specified location name, in the form of latitude and longitude coordinates, or otherwise), may indicate that the specification location is to be used as the map center (which may be an approximate center), may specify a desired zoom factor or percentage, may specify a desired map (e.g., terrain, photographic, road, or hybrid), and may specify one or more overlays (e.g., to indicate the locations of the events identified at block 108B, to indicate activity routes, indicate activity types, indicate conflicts between events at a location or locations, etc.). An element may be created to hold the map and cascading style sheets (CSS) may be used to size the element, and hence the map (e.g., by defining a width and height in pixels). The map request may be transmitted over the network to a remote map system/GIS (geographical information system).

At block 112B, event conflicts at the requested location may be identified. For example, if the location request received at block 104B overlaps an existing scheduled event at the location on one or more dates, a conflict may be identified. Optionally, a conflict may be identified even if no other events are calendared for the requested location, as identified by location name or address(es). By way of illustration, if the user specified a portion of a city block as the location, the requested location may be associated with a first geofence that defines a location perimeter or extension beyond the requested location (e.g., an additional 50 meters beyond the specified city block portion). Optionally, the first geofence may be compared with geofences of other locations reserved for that same date proximate to the requested location (e.g., within 10 feet, 100 feet, 200 feet, 500 feet or other threshold distance) to determine if the first geofence overlaps with other geofences (e.g., if longitude/latitude coordinates associated with the first geofence fall within longitude/latitude coordinates of one or more other geofences). If the first geofence overlaps with one or more of the other geofences, a conflict determination may be made. If a conflict is identified, a conflict alert may be generated and transmitted via one or communication channels to one or more networked destinations (e.g., via email, web page, instant message, short and/or multimedia messaging service (SMS/MMS) message, fax, hard copy correspondence, phone, or otherwise) according to one or more algorithms, rules, and/or distribution lists. The conflict may also be displayed via a hybrid calendar/map interface (e.g., by emphasizing the conflicted location via an icon, color, and/or perimeter in the map and/or in a calendar entry).

At block 116B, the merged hybrid calendar/map is generated, rendered, and displayed on the user device, although optionally a calendar user interface may be provided without the map.

FIG. 1G illustrates an example hybrid calendar/map user interface. The example hybrid calendar/map user interface depicts a month display, although a day, week, multi-month or year display may be chosen. The process generates a summary that lists the jurisdictions that have scheduled events for a selected date or dates (where the dates may or may not be sequential), the corresponding location names, the corresponding location types, and the corresponding event types. The date selection may be performed by the system to correspond to the dates specified in the user request, or the selection may be manually performed by the user “clicking on” or otherwise selecting a date in the rendered calendar. The rendered calendar (the calendar for February in the illustrated example) may display for each day what jurisdiction have events scheduled, the event types, and/or the location or location types. In the illustrated example, the entry for February 1 indicates that counsel districts 4, 1, 7, have respective construction, first amendment, and miscellaneous events scheduled, and that the location type for counsel district 4 is a park. Below the calendar are event details that include the event name, the jurisdiction name, address type (e.g., single or multiple addresses), address, event start and end dates, notes (e.g., hours location is open), use levies, preparation and/or cleanup levies, location type, and/or event type. A map link may be provided. In response to the user activating the map link, a corresponding map may be generated (e.g., using map tiles received from the map system). Optionally, a user interface similar to that illustrated in FIG. 1H may be generated, rendered, and displayed.

FIG. 1H illustrates an example hybrid calendar/map. As similarly discussed above with respect to FIG. 1G, the example hybrid calendar/map user interface depicts a month display, although a day, week, multi-month or year display may be chosen. The process generates a summary that lists the jurisdictions that have scheduled events for a selected date or date range, the corresponding location names, the corresponding location types, and the corresponding event types. The date selection may be performed by the system to correspond to the dates specified in the user request, or the selection may be manually performed by the user “clicking on” or otherwise selecting a date in the rendered calendar. The rendered calendar may display for each day what jurisdiction have events scheduled, the event types, and/or the location or location types.

Below the calendar a map is displayed that includes the subsets (e.g., counsel districts) of a selected municipality at which events are scheduled on the selected date(s). Coded event indicators may be provided that indicate where events are scheduled, the event types, and/or the location types. Controls may be provided that enable the user to zoom in or out with respect to the map, that enable the user to change the center point of the map (e.g., by clicking on a desired center point), and that enable the user to filter the locations and/or event types displayed. Below the map are event details that include the event name, the jurisdiction name, address type (e.g., single or multiple addresses), address, event start and end dates, notes (e.g., hours location is open), use levies, preparation and/or cleanup levies, location type, and/or event type.

Optionally, if a conflict is detected, although a conflict alert is generated, the hybrid calendar/map user interface is not generated, transmitted, or rendered to reduce network bandwidth utilization and the load on the user's device computer. Instead, an instruction may be generated and provided to the user (e.g., as part of the conflict alert) instructing the user to select a different location and/or a different date. Optionally, the location request user interface is automatically again presented to the user, prepopulated with the prior user entries and selections so that the user does not have to reenter all the entries and selections, and instead may simply edit as needed or desired (e.g., edit the location and/or dates).

!!!FIG. 1I illustrates another example user interface configured to enable a user to create or edit a calendar entry. The user interface includes fields for title (which may be in the form of text field configured to receive user entered text), political jurisdiction, location name, location type, event type, and a public property location identifier (e.g., a number or other code that uniquely identifies public property location in a public property location database). In addition, fields are provided via which a user can indicate whether a requested location is a single property address, or includes multiple addresses. Fields are provided via which a user can specify a start address for a desired location and a zip code. The system may attempt to identify and map the user specified address, and provide for display a located complete address and a map with the corresponding location indicated (e.g., via a text cloud or bubble with a pointer). The user interface may prompt the user, via a prompt overlaying the map and pointing to the location and displaying the located address (which may be in the form of the bubble), to confirm whether the address identified by the system is correct or not. The prompt may include user input controls (e.g., links) via which the user can indicate whether or not the mapped location and displayed address is correct. In response to the user indicating that the address is incorrect, the system may reset all of the user interface fields or a subset of the user interface fields (e.g., the street address and zip code fields) so that user may attempt to provide a correct or more accurate address.

A control may be provided that enables the user to instruct the system to set a pin (or other indicator) at the location identified in the map. If the user instructs the system to set a pin, the pin may be set at the location as illustrated in FIG. 1J. An override control may be provided which enables the user to instruct the system to use the address specified by the user and not the address located by the system. Fields may be provided via which the user can specify event start and end dates, and via which the user can indicate whether the event is a recurring, and if so, how often and at what interval (e.g., daily, weekly, monthly, yearly, every Sunday, Monday, Tuesday . . . Friday, etc.). Fields may be provider for user notes and comments. Controls may be provided via which the user can provide attachments or links to attachments for upload to the system (e.g., videos, photographs, audio recordings, documents, etc.).

FIG. 1K illustrates the user interface of FIG. 1I where the user has specified a route that includes multiple addresses. As illustrated, the map includes a route marker (e.g., a bold line of a predetermined color) with start and end pins. The user interface enables the user to drag either end of the route marker in any direction to change the route being requested with respect to the event scheduling. Thus, the map may be used to specify a range of locations for a scheduled event. The user interface may also enable the user to specify a two dimensional open or closed perimeter, which may be illustrated in the map, as depicted in FIG. 1L.

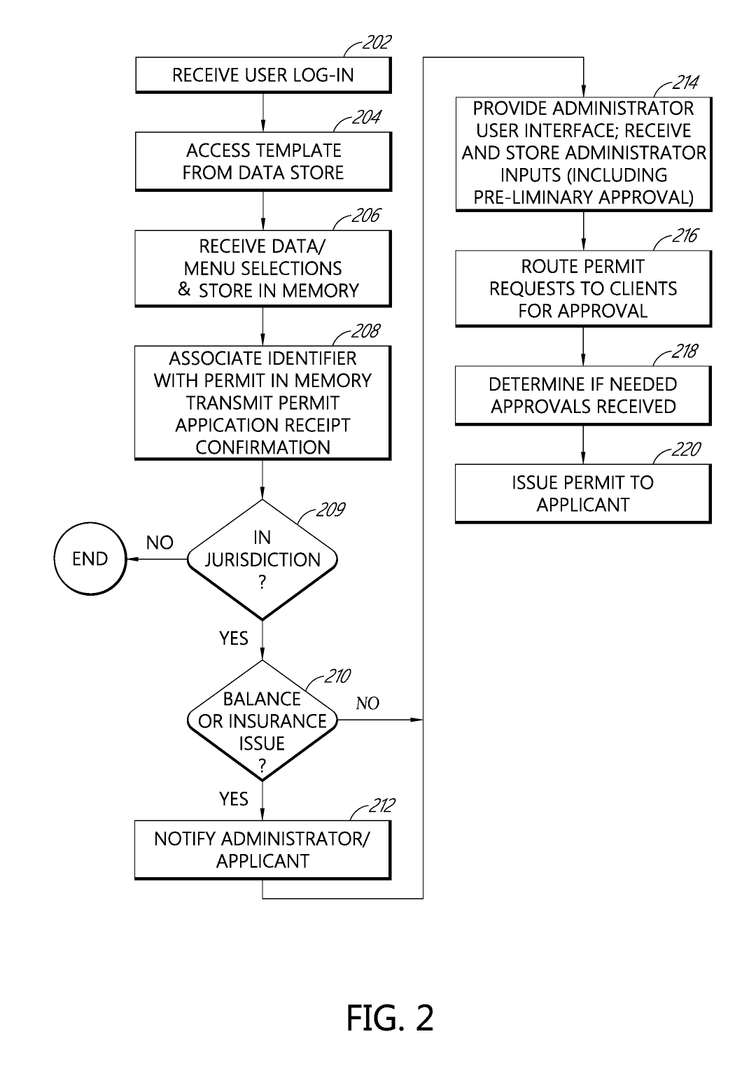

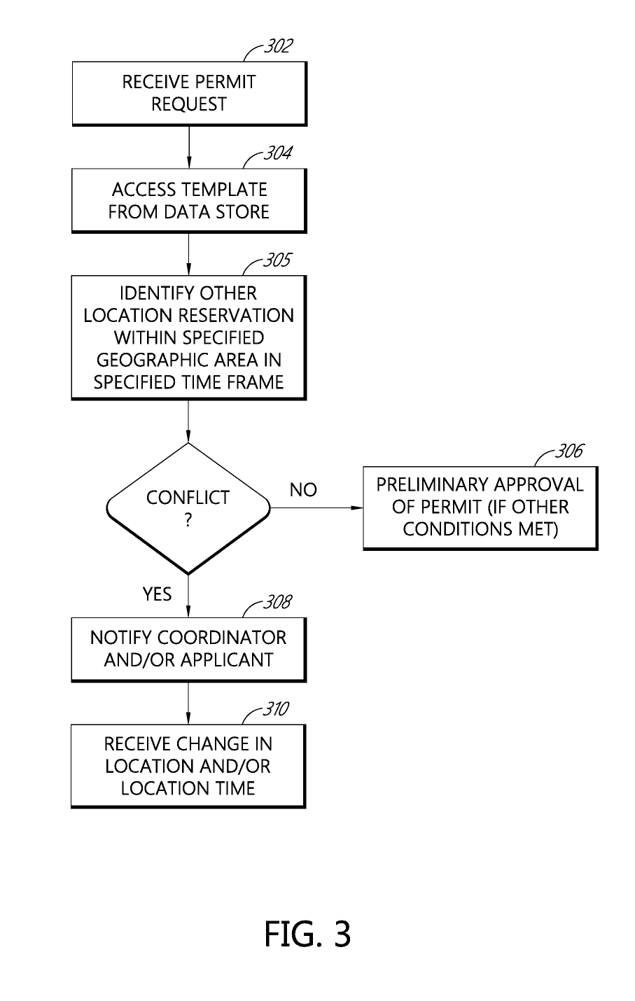

The foregoing processes, interfaces, and systems may be used in conjunction with a filming permit application process. For example, a user requesting a filming permit may submit the request, including the location and date, using one or more of the interfaces described herein. The request may be processed using the processes illustrated in FIG. 1B, FIG. 2, FIG. 3, and/or other processes as described herein or any combination of the states thereof.

An example embodiment, that optionally utilizes the mapping and calendar processes, interfaces, and systems described herein, facilitates planning, communication and data transfer between multiple entity types, such as a permitting agency, permitting agency clients (e.g., city agencies, such as police, fire departments, etc., whose approval is needed as part of the permit approval process), permitting agency customers (those seeking permits), and other entities (such as private citizens or businesses) who are to be notified regarding filming in their geographical area.

Further, example embodiments provide for the generation of permits, the assignment of personnel to monitor the locations on a permit, the collection of levies (e.g., fees) associated with the filming activity, and the routing of permit applications to one or more agencies for approval. Further, example embodiments provide communications techniques, such as e-mails, requests, notes, and comments, to enable groups to effectively communicate and coordinate with each other.

Certain example embodiments enable a permit applicant to create and save permit application templates for future permit applications via corresponding user interfaces (e.g., via web pages served by the computer-based process system over a network) provided for display on a user terminal. This enables a reduction in repetitive data entry when generating permit applications.

By way of example, a permit may specify some or all of the following: location, date, time, shooting category (e.g., motion, still, movie, commercial, television show, etc.), contact information, coverage (e.g., insurance) information, size of cast and crew, filming activities and equipment used, requested lane or road closures, number of trucks, power/water service requests, special filming conditions, etc.

When a permit request (e.g., in the form of a permit application) is received at the permit computer-based process system, the permit application information is stored in computer readable memory. The permitting computer-based process system optionally transmits to the permit applicant substantially instant confirmation that the permit application was received. For example, the confirmation can be transmitted to the applicant's terminal via a web page notification, an email, an instant message, or otherwise. The computer-based process system enables applicants to modify the permit application after it has been submitted to the permitting agency. Further, certain embodiments automatically validate a permit applicant's coverage policy for the applicant's filming.

Certain embodiments of the permit computer-based process system provide substantially real-time status updates to the applicant regarding the permit application processing progress and the status of agency approvals (e.g., approval by particular agencies and/or approval of particular requests, such as approval of road closures, provision of police, emergency medical service personnel, monitors, and/or fire department personnel, city provision of electricity, water, etc., although the status of agency approval may be provided for fewer, additional, and/or different agencies). If a problem with the permit approval process occurs, which may be a problem relating to the requested location or timing of the filming or may relate to applicant data, the applicant can be substantially immediately notified so that the applicant can, where appropriate, address the problem (e.g., select another location and/or time, provide updated coverage information, take care of a past due account balance, etc.). This enables problems to be identified (by the system and/or a human) and rectified quickly, to thereby enable appropriate conforming permits to be promptly approved and issued. Examples of the types of permitting problems that may arise can include, but are not limited to:
the filming location is already being used by another applicant at the requested time;
a nearby location is already being used by another applicant at the requested time (e.g., where the nearby location is in within a specified distance of the requested filming location);
the location will be unavailable because of maintenance work;
the applicant's coverage has expired;
the applicant has a past due balance (e.g., with respect to permit levies);
etc.

Similarly, the system can automatically detect certain issues (e.g., a time/location conflict, coverage problems, account problem, etc.), and notify an appropriate permit process administrator (e.g., via email, SMS message, instant message, web page message, or otherwise), who can take appropriate action to resolve the issue.

With respect to levies, a permit is typically associated with levies. The levies may include a static amount (e.g., a fixed levy for the permit) and a dynamic portion (e.g., to cover the hourly, per person rate of police, EMS, monitors, fire department, and/or other entity presence at the filming location). Certain embodiments generate an estimate for the dynamic portions and total the static amount and the estimated portion to generate a total amount. The total amount can be presented to the applicant, and the applicant can then be billed for that amount.

For example, the estimated levy may be generated based on the permit request information (e.g., request or need for fire department, police department, and/or other government personnel need to be present, request for water or electricity services from department of water and power, an indication that damage may be done to the location, etc.), and on historical data for location shoots having one or more similar characteristics to that associated with the permit request.

Certain embodiments optionally include an accounting module to assist in the tracking and collection of levies associated with each permit. For example, the accounting module can compare estimated levies for permits with actual or final permit levies (which may differ from the estimated levies based on the actual length of the shoot, damage done during the shoot, and city services used during the shoot, etc.). The account module can then bill or remit the difference to the applicant, and route any additional appropriate levies to the designated recipient (e.g., to a city agency based on services provided).

Optionally, the permit computer-based process system include an administrative module that enables the permitting agency to add, modify or delete levies, to modify the user interface, add or modify bulletins, add community comments, modify assignment rotations, and to specify reports.

As similarly discussed above, the permit computer-based process system enables clients (e.g., government approving agencies) to review permit details and grant or deny agency approval. Real-time data availability relating to the permit application and of the approval process enables clients to view current filming activity detail, as well as changes, additions and removals relating to the permit application and of potential conflicting permits, giving the clients/approving agencies the ability to make informed decisions regarding each location and film shoot.

Optionally the permit computer-based process system tracks requests for community notification. For example, certain embodiments enable the permitting agency to create and modify notifications for distribution to the community. By way of illustration, neighbors (e.g., residents and/or businesses within a certain area around or adjacent to the filming location) can request (via a user interface provided as a web page by the computer-based process system, via a phone call to an person or interactive voice response system, via an email, via a letter, or otherwise), to be notified when filming will take place within a certain distance from the notification requester. The requester can enter in or otherwise specify a notification destination (e.g., an email address, an SMS address, or other address). The computer-based process system will then accordingly transmit the notification to the community (e.g., those who requested a notification within the community and/or those who are in a specified area relative to the filming location even if they did not request a notification) a predetermined amount of time prior to, and optionally at the time of the filming.

Example embodiments and aspects thereof will now be discussed with reference to the figures.

FIG. 1M illustrates an example computing system operating environment. In discussing example embodiments, the term “Website” is used to refer to a user-accessible server site that implements the basic World Wide Web standards for the coding and transmission of hypertextual documents. These standards currently include HTML (the Hypertext Markup Language) and HTTP (the Hypertext Transfer Protocol). It should be understood that the term “site” is not intended to imply a single geographic location, as a Web or other network site can, for example, include multiple geographically-distributed computer systems that are appropriately linked together. Furthermore, while the following description relates to an embodiment utilizing the Internet and related protocols, other networks, such as networked interactive televisions, and other protocols may be used as well.

In addition, unless otherwise indicated, functions described herein are preferably performed by software including executable code/program instructions running on one or more computers. The computers can include one or more central processing units (CPUs) that execute program code and process data, computer readable media, optionally including volatile memory, such as random access memory (RAM) for temporarily storing data and data structures during program execution, non-volatile memory, such as a hard disc drive, optical drive, or FLASH drive (e.g., for storing programs and data, including databases, which may be referred to as a “system database,”) and a network interface for accessing an intranet and/or Internet. In addition, the computers can include a display via which user interfaces, data, and the like can be displayed, and one or more user input devices, such as a keyboard, mouse, pointing device, microphone and/or the like, used to navigate, provide commands, enter information, provide search queries, and/or the like.

However, the system can also be implemented using special purpose computers, terminals, state machines, and/or hardwired electronic circuits. In addition, the example processes described herein do not necessarily have to be performed in the described sequence, and not all states have to be reached or performed. While personal computers or laptops may be referenced herein, other terminal types can be used as well, such as interactive televisions, phones, etc.

With reference to FIG. 1M, the permit computer-based process system 102 includes a web server 104 and a database 106 (which optionally includes one or more databases). The database 106 can store applicant account information (e.g., name, contact person, address, contact information, etc.), applicant permit applications, permit status information (e.g., open, hold, hold for accounting/billing issue, hold for coverage issue, hold for approvals, locked from change, closed, etc.) location information, road conditions, local construction, etc. By way of further example, the stored location information can include addresses, a map grid number, one or more pictures or links to pictures of the location, location specific conditions (e.g., availability of parking, sensitive neighbors, etc.), shooting restrictions, levies (special levies or any levies), an indication as to whether the location is in a fire zone (or other zone which may necessitate special precaution or which may be associated with addition filming restrictions), which council district (or other governmentally defined area) the location is in, police jurisdiction, etc.

The database 106 optionally stores permit levy structures, algorithms for generating levy estimates, approving agency approvals, filming activity, personnel and equipment on location, lane and street closure information, special conditions which affect the specific location and filming activity, etc. Some or all of the foregoing information may optionally be manually entered by an administrator or other entity via a user interface provided for display by the computer-based process system 102 and/or some or all of the information may be electronically accessed from another data source. As discussed below, some or all of the foregoing information may be used in determining, using the system 102, whether a permit is to be granted.

One or more administrative terminals 108, 110 may be coupled to the web server 104. For example, terminal 108 may be operated by a permitting agency coordinator that coordinates the initial application through the approving agencies until it can be issued to the applicant as a final document. By way of further example, terminal 110 may be operated by a permitting agency operations manager that has a higher level of permissions with respect to the system 102 and permitting process than the coordinator. For example, the operations manager optionally may be provided with the ability to override and approve a wide variety of issues that may arise (e.g., change levies, allow a permit to be issued even if a conflict exists, etc.), that the coordinator cannot. The system 102 may determine the level of permissions a given user has based on user login information (e.g., user ID and/or password), which are used to access from computer readable memory the permissions associated with the user.

The computer-based process system 102 is connected via a network 112 (e.g., the Internet, an intranet, or other network) to one more applicant terminals 114 (e.g., personal computers, interactive televisions, smart phones, etc.). As described elsewhere herein, the computer-based process system 102 can transmit templates/permit user interfaces to the applicant terminals 114, and can receive back the applicant entries (e.g., from an applicant location manager). The system 102 can store the entries in the database 106. Optionally in addition or instead, some or all of the permit information can be received via an email, via a fax, or via a hardcopy paper application. In addition or instead, an operator can manually enter the data.

The system 102 can further transmit substantially real time permit processing status updates to the applicant (as well as administrators and approving agencies) and can receive applicant specified permit changes via the terminals 114.

The computer-based process system 102 is optionally further coupled to one or more client systems 116 via the network 108. The client systems 116 may be operated by approvers, which may be government agencies that approve (in whole or in part) the filming activity at requested locations for the specific period of time. The computer-based process system 102 can serve user interfaces (e.g., via web pages) providing relevant permit detail information, and via which the client can provide their approval.

The computer-based process system 102 is optionally further coupled to one or more user systems 118 via the network 108, wherein the user systems may be operated by those that have requested notification of filming in their area. The computer-based process system 102 can track permits (e.g., issued permits), identify users living within a specified geographical area in and around the filming location to whom notification is to be provided, and then transmit such filming notification to the terminals 118 a specified period before and/or during the scheduled filming.

FIG. 2 illustrates an example permit process. At state 202, an applicant logs into the process system (e.g., via an applicant terminal coupled to the computer-based process system via a network). At state 204, the computer-based process system accesses from a data store a form template previously defined by the applicant, or provides a user interface via which the applicant can define a template). The form template may be used to specify and receive information needed in order for the permit to be submitted.

For example, the template may provide fields via which the applicant can specify general company and contact information. Optionally, the applicant may instruct the system to automatically copy data from a previous permit associated with the applicant. The system will access the previous permit data and copy the data into the new permit. Optionally, only relatively static data is copied, such as general company and contact information, while more dynamic types of data, such as location information and filming activities, will not be copied, and instead, the applicant will be asked to supply such dynamic information. Optionally, the applicant may copy static data from a previous location onto another location. In this case, filming activities, equipment and personnel on location, etc. will be duplicated onto another location or to a copy of the same location. Dynamic data, such as dates and times, will not be copied and need to be manually input. Optionally, a fixed permitting agency-defined form may be used rather than the applicant template.

The form may optionally include a menu (e.g., a drop down menu) of predefined locations which may be selected by the applicant and reserved. For example, the predefined locations may include popular shooting locations, such as landmark buildings, sports facilities, museums, beaches, etc. If the applicant's desired location is not listed on the menu, the applicant can manually enter the address and/or name of the location (e.g., where there is no address, such as for a stretch of beach or intersection) via a location address/identifier field. Optionally, the menu is administrable.

The form may optionally include a menu of predefined filming categories which may be selected by the user. For example, the filming categories may include feature film, made for television movie, documentary, situation comedy, dramatic television show, commercial, music video, still photography, corporate video, etc. Optionally, the menu is administrable.

Optionally, the form includes a menu via which the applicant can specify special shooting conditions for the permit (e.g., gunshots, crashes, pyrotechnics, etc.). If the menu does not include an appropriate shooting condition, the user can enter the shooting condition in a shooting condition field. Optionally, the menu is administrable.

If contact information is not already included in the form, the applicant can manually enter the contact information via contact information fields (e.g., applicant name, contact person, phone number, physical address, email address, etc.). In addition, the applicant can modify information already included in the form.

At state 206, the applicant data/menu selections are received at the computer-based process system, which stores the data/menu selections in memory. Based on the data entered by the applicant, the computer-based process system, optionally using artificial intelligence, will provide additional user interfaces, including appropriate data fields for entry by the applicant.

At state 208, the computer-based process system associates a unique identifier with the permit application (which is stored in memory in association with the permit request), and transmits a confirmation notification (e.g., via email or otherwise) to the applicant, the confirmation optionally including the unique identifier. At state 209, a determination is made as to whether the specified location is out of the permitting agency jurisdiction. If the specified location is out of the permitting agency jurisdiction, a notification is provided to the applicant, and the permit is not issued by the system.

If, at state 210, the computer-based process system determines (from data accessed from the system database) the applicant has an outstanding balance (e.g., resulting from levies owed relating to previous filming and permits), the applicant is so notified (e.g., via an email or web page), and a hold for billing status is recorded in association with the permit application.

Similarly, the computer-based process system determines if there are issues with the applicant's coverage information that may prevent issuance of the permit, and if there are, a hold for coverage status is recorded in association with the permit application. For example, the computer-based process system can determine the applicant's coverage has expired via expiration data information previously entered by the applicant and stored in memory or via expiration information obtained from the insurer or its agent. By way of further example, based on some or all of the following: the applicant's coverage limits, the shooting location, special shooting condition(s), number of trucks, other permit information, etc., the computer-based process system determines whether the applicant's coverage limits are sufficient.

At state 212, if there is an issue with a past due balance or coverage, the computer-based process system also notifies a permitting agency administrator to review the issue and, if needed, to work with the applicant to resolve the issue. The administrator optionally can indicate via an administrator user interface that the permit is to be placed on hold (pending resolution of the outstanding issues). Once the issue is resolved (as indicated by the administrator via a status control user interface), the corresponding hold status is removed.

Optionally, the process system will examine the current work loads of appropriate administrators and assign such issues to administrators so as to balance the workload substantially evenly across the administrators. The process of balancing the workload evenly, optionally uses artificial intelligence, and optionally takes into account performance and/or experience levels of administrators (as indicated in a data store), so that a very experienced administrator may be assigned a first number of cases in a certain time period, and a less experienced administrator may be assigned a significantly lower number of cases in that same time period. Optionally, permit applications will be assigned on a rotational basis. Optionally, a supervisor or other administrator with the appropriate position can instruct the computer-based process system to override the rotation and change the rotation.

Optionally, a control is presented via the administrator terminal via which the assigned administrator (e.g., coordinator) can refuse the assignment. Optionally, the system then automatically reassigns the issue to another administrator. Optionally, instead, a supervisor is informed of the refusal and can approve or disapprove the assignment using a corresponding control displayed on the supervisor control. If the supervisor approves the refusal, the system then assigns the issue to another administrator as similarly described with respect to the initial assignment. Optionally, the user interface does not include a control via which the assigned administrator can refuse an assignment.

Optionally, an administrator may have been previously assigned to handle permits associated with a specified title or applicant. If so, the computer-based process system will read such an indication from a data store, and notify that administrator when an issue arises regarding permits for that title or applicant.

At state 214, a user interface is provided by the computer-based process system via which the administrator can retrieve from a data store special conditions by permit type and/or location, and via which the administrator can associate the special condition(s) by permit type. In addition, optionally a user interface is provided via which the administrator can enter shooting restrictions to be placed on the permit as they relate to the shooting (where the restrictions will optionally be listed on the issued permit).

In addition, optionally a user interface is provided via which the administrator can add, delete, or modify signoff requirements (by the clients/approving agencies and/or permitting agency personnel/groups). Optionally, a user interface is provided via which the administrator can change levies. Optionally, depending on the level of permissions the administrator has, the administration may only be permitted to alter certain levies (e.g., those payable to the permitting agency), and not others. Optionally, when some or all of the foregoing changes are made, another administrator (e.g., a supervisor) is automatically notified by the system. Optionally, prior to certain or any of the changes going into effect, the supervisor (or other appropriate permissioned person) needs to approve the change (e.g., via a user interface presented by the system), prior to the system applying the changes.

At state 216, once the permit request has been initially approved by the permitting agency, the permit is then routed serially or in parallel to one or more clients (e.g., via email or web pages transmitted to a client terminal, via fax or mailed forms, or otherwise), and a “hold for approvals” status is recorded in association with the permit application. For example, the clients may be governmental and/or non-governmental entities, such as the police department, the fire department, parks department, street maintenance department, or other entity whose approval is needed. The list of entities whose approval is needed may be varied based on the computer-based process system's analysis of the permit request information or by manual intervention by an administrator. For example, if there are pyrotechnics, fire department approval may be needed. If no special conditions are specified for the filming, then in certain circumstances fire department approval may not be needed.

At state 218, a determination is made as to whether each entity provided permitting approval. Based on the location and filming activities, the permitting computer-based process system (e.g., operated by a permitting agency) requests approval from the appropriate clients (e.g., approving agencies). The pending request can be transmitted to the client's terminal via a web page notification, an email, an instant message, or otherwise. The client, or approving agency, completes the approval communiqué, taking into account the specific location and filming activities, then approving, denying or saving the permit request until a later time. During the foregoing process, the permit application is put into a hold status (which is stored by the computer-based process system). Once all of the needed approval requests have resolution, the corresponding hold status is automatically removed by the computer-based process system.

At state 220, if the foregoing approvals are obtained, if the applicant coverage is in order, if the applicant does not have an outstanding balance, and if a conflict does not exist, then the permit receives final approval (of course fewer or more conditions may need to be met). The permit is then issued to the applicant. For example, the permit may be electronically emailed and/or downloaded to the applicant terminal (e.g., as a PDF file or other file type), and the applicant can then print out the permit. Optionally, in addition or instead, the permit may be mailed or faxed to the applicant.

During the foregoing process, the applicant, clients, and permitting agency are optionally provided with real-time updates on the processing of the permit. The updates may be provided via a push facility (e.g., via emails, faxes, phone calls, SMS messages, etc.) to the notification recipient, or an interested party (e.g., the applicant, clients, and permitting agency) can access the permit status via a website, such as the permitting agency website.

Certain embodiments provide additional features, including complaint processing. If complaints are received regarding a particular shoot (e.g., via email received at the process system, via fax, a letter, a phone call or otherwise), the complaint is stored in system memory, the computer-based process system determines which coordinator (or other person) is assigned to the shoot/related permit, and the complaint is routed for display to the coordinator assigned to the film permit. The coordinator can categorize the complaint into one or more complaint types, and can enter notes and resolution information into the computer-based process system. The computer-based process system can calculate and provide for display complaint volume trending by applicant and/or location, can provide for display daily complain reports, and can provide for display complaint summaries by a combination of variables (e.g., date, location, any types of complaints).

Further, certain embodiments optionally provide GIS (geographic information system) functionality. For example, the computer-based process system can access addresses/location identifiers from a database (e.g., associated with issued, pending, or closed permits) or entered by a user (e.g., an applicant, administrator or other user) into a form. The system can compare the address/location information to determine if the address/location exists using an internal database and/or an external database (e.g., such as that associated with Google, Microsoft, Yahoo, or other entity). If the address/location does not exist in the database, a notification is automatically provided to the appropriate person (e.g., the applicant and/or an administrator) so that the address/location can be corrected/clarified.

If the address is accurate, the system or a third party accesses global position coordinates associated with the address/location. For example, if the address/location is from a permit application, a map may be provided for display to the applicant and/or administrator including the address/location. The map may include the actual location (e.g., highlighted with a visual pin, border, or other highlighting technique) and the surrounding area. The map may include an actual photograph (e.g., an aerial, space, and/or street view photograph) of the location and surrounding area, a graphic map showing streets and addresses, or a hybrid map, wherein a photograph of the location and surrounding area is overlaid with map graphics map showing streets and addresses.

Optionally, the map will further display the locations (e.g., highlighted with a visual pin, border, or other highlighting technique) of other locations already reserved within a specified area and a specified time frame relative to the location and the date/time of that requested in the permit application. The map and/or adjacent text will optionally identify conflicts (e.g., using a color coding, icon, a border, permit numbers, and/or other technique to indicate which reservations are in conflict).

Optionally, the map will also indicate (e.g., by highlighting with a visual pin, border, or other highlighting technique), if a special shooting condition exists at a location. If example, if a location is in a fire hazard zone, a border may be displayed around the zone. Similarly, if the location is in a certain district, a border may be displayed around the district.

The map may also indicate one-way streets, parking availability, road work, road closures, accidents, and/or other items of interest.

FIG. 3 illustrates an example conflict identification and resolution process. The process can be used to determine if a requested filming time and location are sufficiently close to another filming event time and location to potentially cause a problem (e.g., as there may be too many trucks or street closures, which are likely to cause an unacceptable amount of traffic disruption, parking problems, and/or other problems).

At state 302, the computer-based process system receives a permit request, including a time and location, and optionally the types of information as discussed above (e.g., the number of trucks and other support equipment and vehicles that will be used, whether street closures will be needed, etc.). At state 304, the system accesses a data store, such as the database discussed above, and identifies if other location requests and/or approved permits exists for locations within a specified distance or within a specified area of the requested location, where the shooting is to take place at the same time or within a specified period of time as the requested time. The specified area and time period may be selected so that if the requesting time and location is within the specified area and time period, the system will indicate a conflict exits. At state 306, if no conflict exists, the permit is preliminarily approved (subject to client approval and/or other conditions).

If a conflict exists, then at state 308, the coordinator assigned to the permit is automatically informed (e.g., via email, a web page, or otherwise) substantially immediately, and the permit is placed on hold (optionally where a “conflict hold” status is stored in memory in association with the permit application). Optionally, the applicant is also informed. Optionally, the communication presents a map to the applicant and/or the coordinator indicating where the competing filming (or other) event is taking place and the filming hours as similarly discussed elsewhere herein.

At state 310, if the applicant modifies the requested location and/or filming time, the process then process back to state 302.

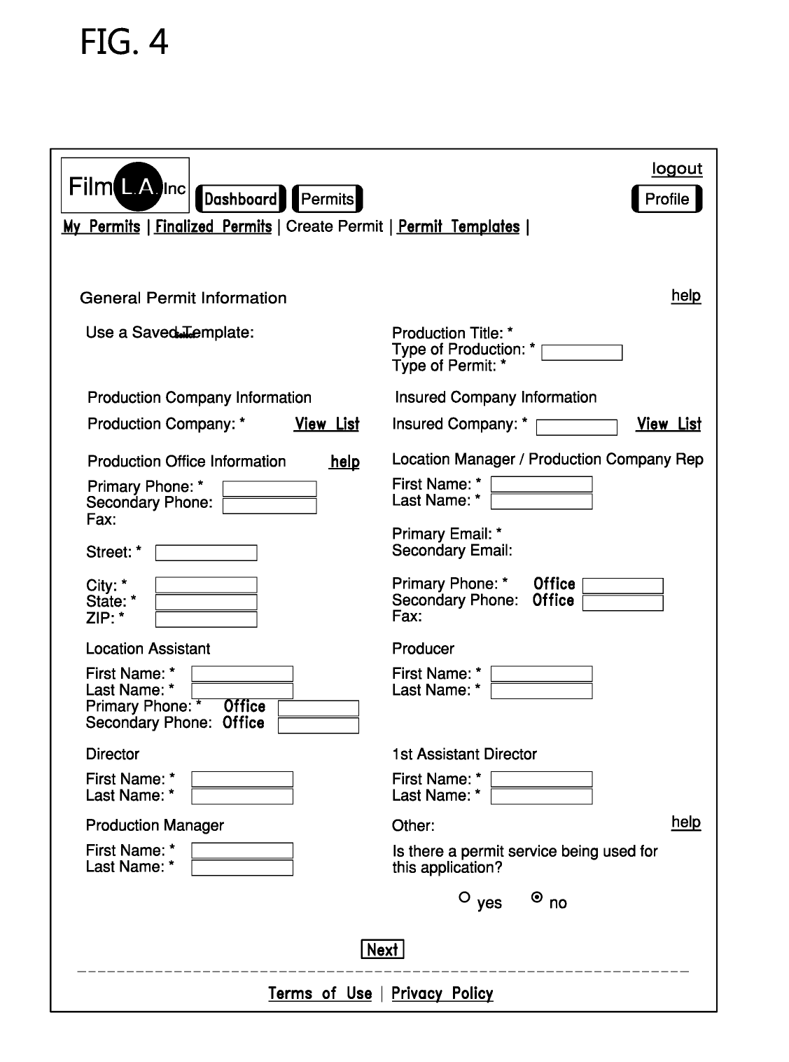

FIG. 4 illustrates an example permit application user interface. In this example, fields are provided for receiving the following information:

The production title, the type of production (e.g., TV reality, feature film, sitcom, documentary, etc.), the type of permit (e.g., filming, still, etc.), production company information including the production company name and their contact information, the insured company name (which may be the same as the production company name), names associated with the producer, the director, the first assistant director, the production manager, the location manager and associated contact information, the location assistant and associated contact information, and the number of locations associated with the requested permit. Additional, fewer, and different fields can be used.

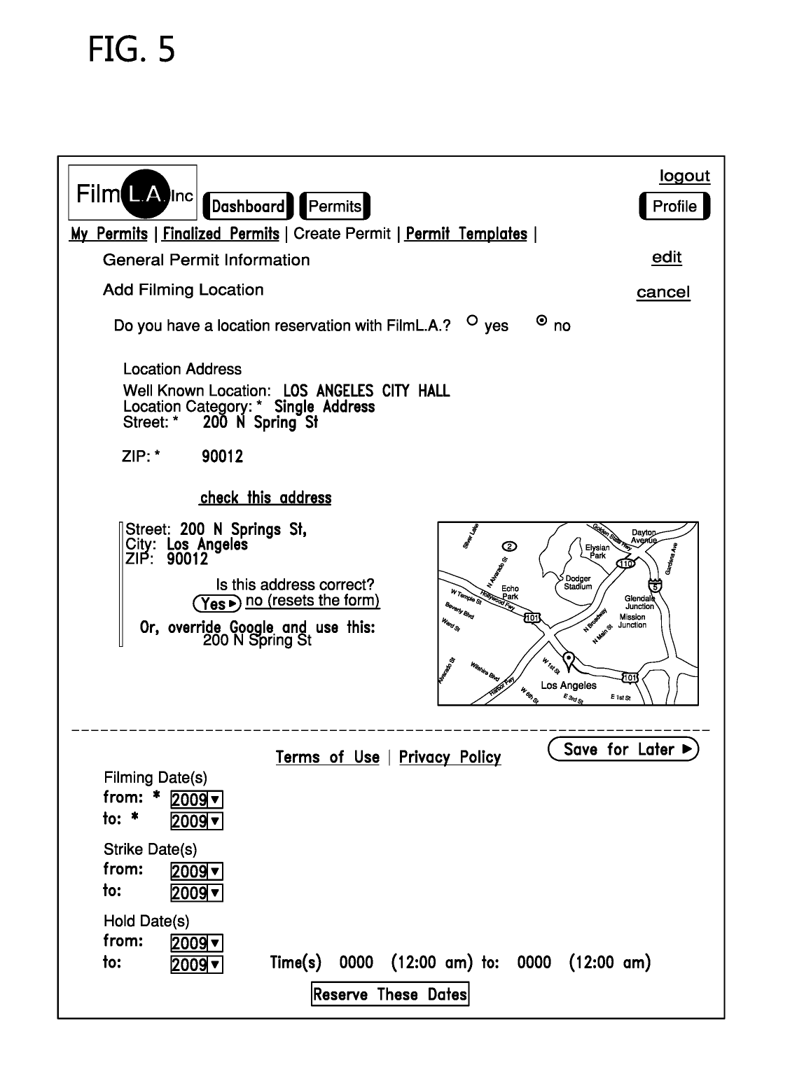

FIG. 5 illustrates an example location selection user interface. The user can select a location via a menu listing popular locations or by entering an address. If the user selects a location from the menu, then the address information, location type, and map data fields are prepopulated using data accessed from the database. In addition, the user interface displays a map corresponding to the address and the surrounding area, with a flag at the specific location. The user interface also prompts the user to confirm that the presented address is correct via a confirmation control (e.g., a “yes” control, a “no” control). If the address is not correct, the user can activate the “no” control, and the address is cleared from the address field. The user can then reenter the address with the correct address.

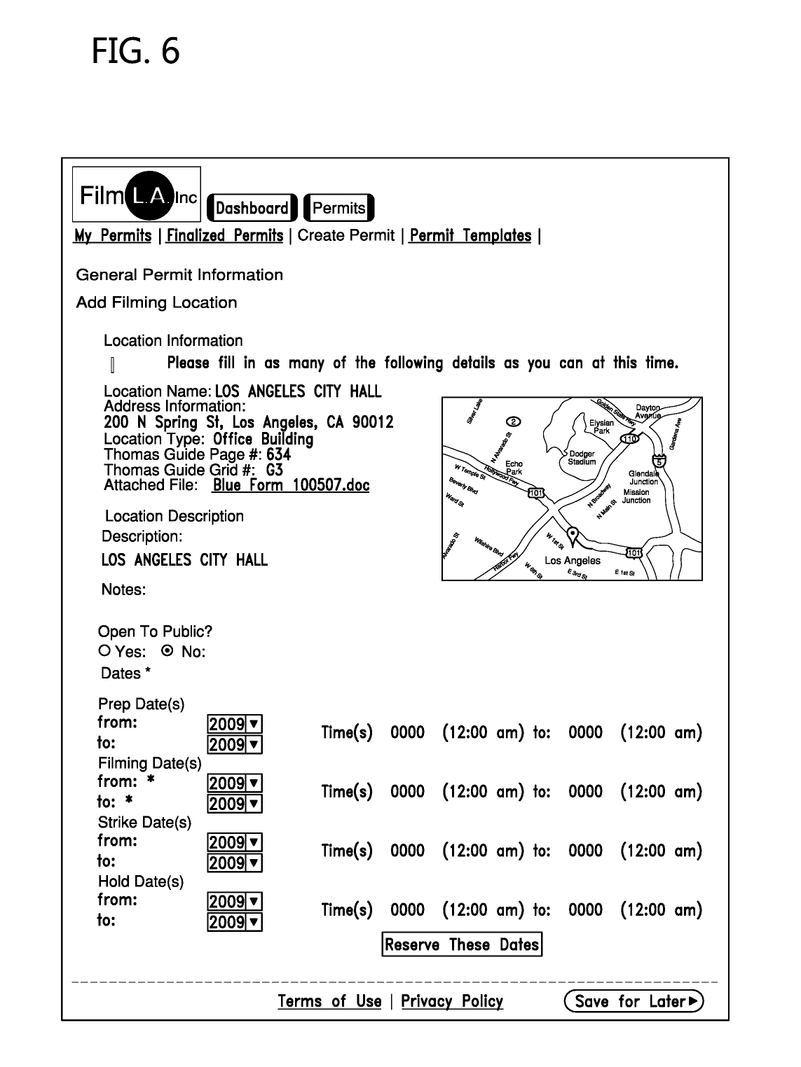

FIG. 6 illustrates an example location reservation user interface. In addition to displaying information displayed via the location selection user interface, a control is provided via which the user can indicate whether the location is to be opened to the public during filming or not. The user can add notes in a “notes” field, and specify dates and times for which the user wants to reserve the location for preparation and filming, as well as strike and hold dates and times.

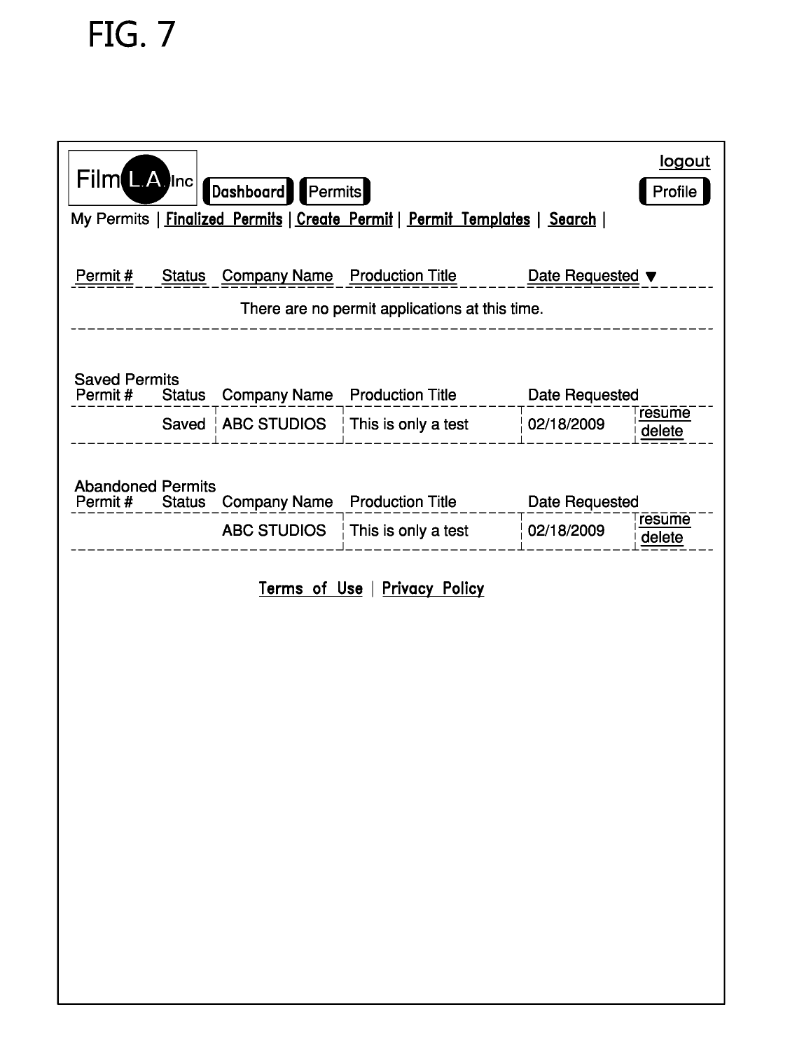

FIG. 7 illustrates a permit status interface listing the user's permits (whether unfilled, pending, issued or expired), the permit number, the permit status, the production company name, the production title, and the date the permit was requested.

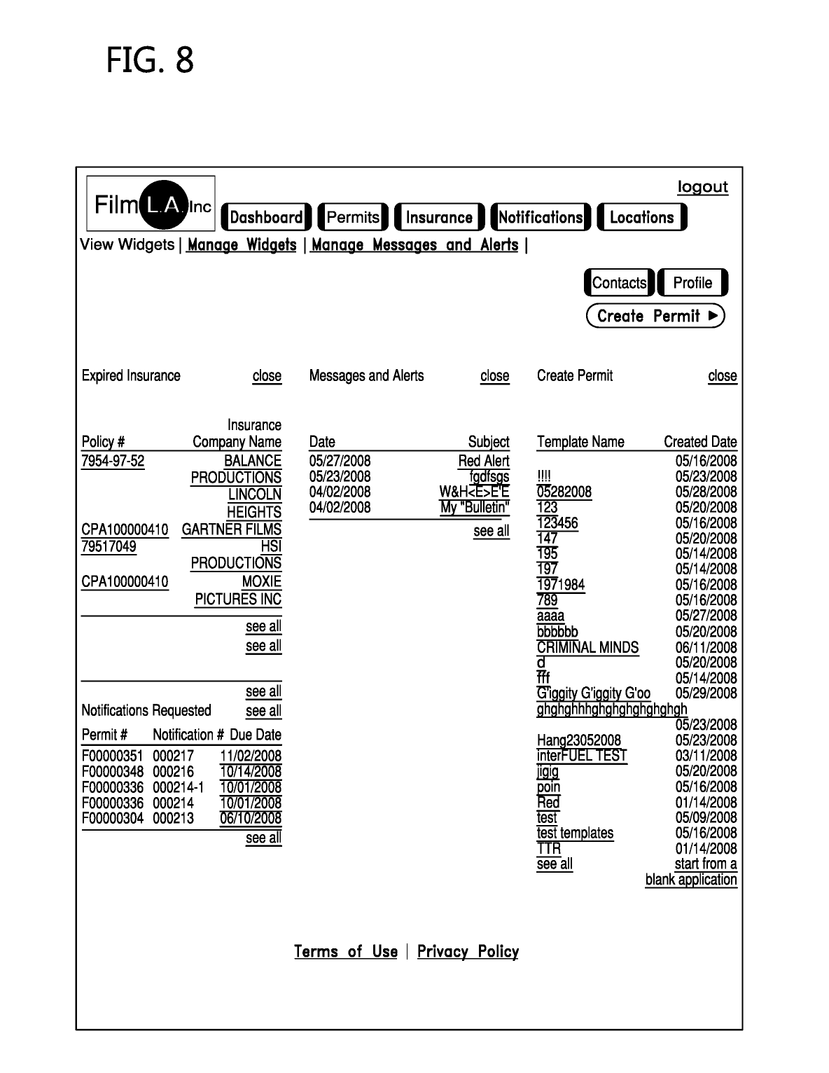

FIG. 8 illustrates an example administrator user interface, which, for example, can be utilized by a coordinator. Optionally, the system inhibits access to administrator user interfaces with respect to applicants and external approving agencies. The user interface lists coverage policies that have expired, including the policy number and the insured company name. The user interface also lists the permits assigned to the coordinator accessing the user interface, including the application date, the date of first activity, and the project title. A section lists the permits associated with notification requests (e.g., by residents/business in the area of the filming location), including the permit number, notification number, and the due date. A messages and alerts section lists message/alert dates and subject. A section lists the permits that are pending manager approval, including the permit number and project title. A create permit section lists template names and template creation dates. A new registration section lists the corresponding names and registration dates. The user interface lists permit assignments, including the name of the coordinators and the number of permits assigned to the coordinators. The operations manager user interface optionally provides similar information and controls.

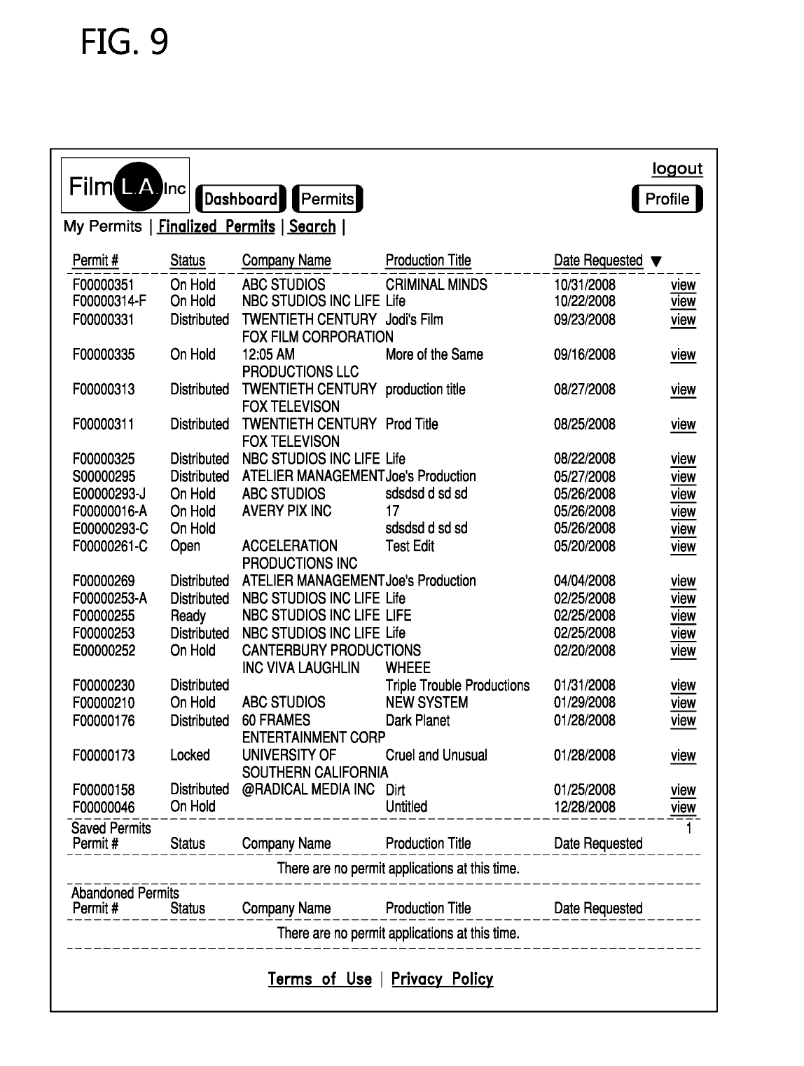

FIG. 9 illustrates an example approver user interface. The user interface lists permits waiting approval by the approver. The user interface lists the permits, including the associated permit numbers, company name, production title, and date requested. A view control, when activated, causes the corresponding permit application to be presented. A saved permit section lists saved permits. An abandoned permit section lists abandoned permit.

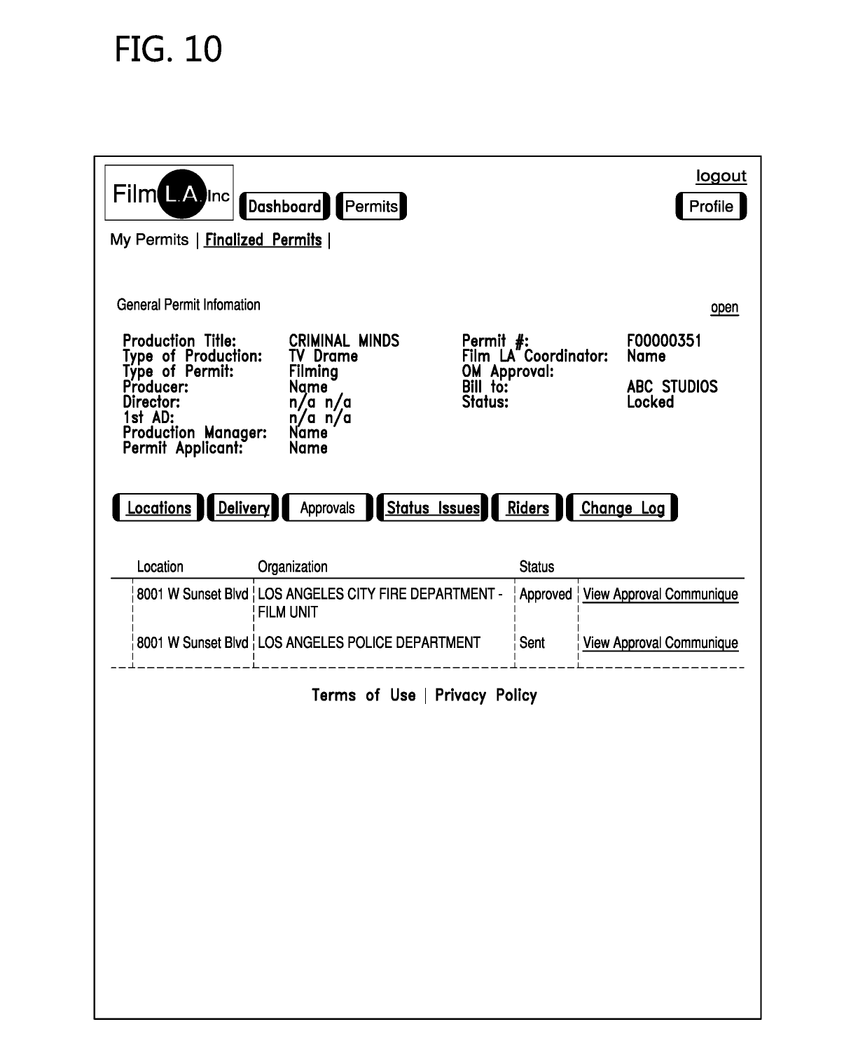

FIG. 10 illustrates an approver user interface providing detailed status information. The user interface lists general permit information and in addition, lists the organizations whose approval is need, and the status of the approval (e.g., sent, approved, rejected, etc.). A link is provided in association with each list approver, that when activated, causes the approval communiqué to be presented.

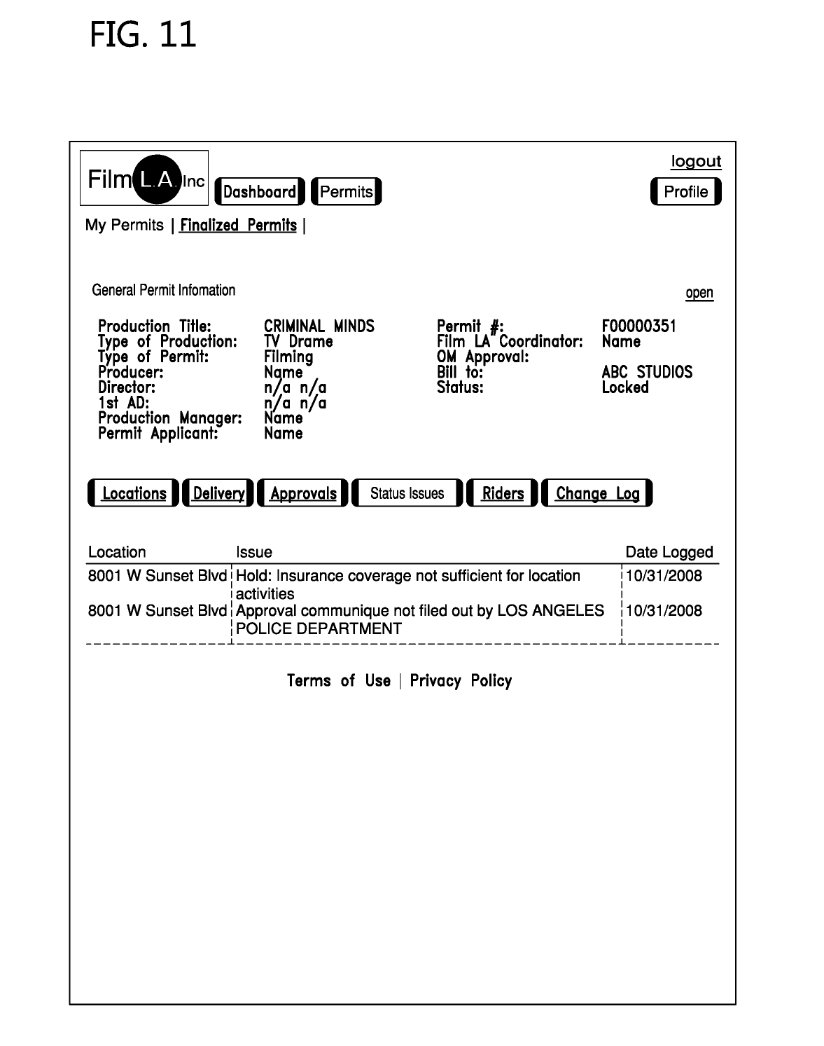

FIG. 11 illustrates an approver user interface providing detailed status information. The user interface lists general permit information and in addition, lists the status issues which are inhibiting issuance of the permit, and the date the corresponding issue was logged.

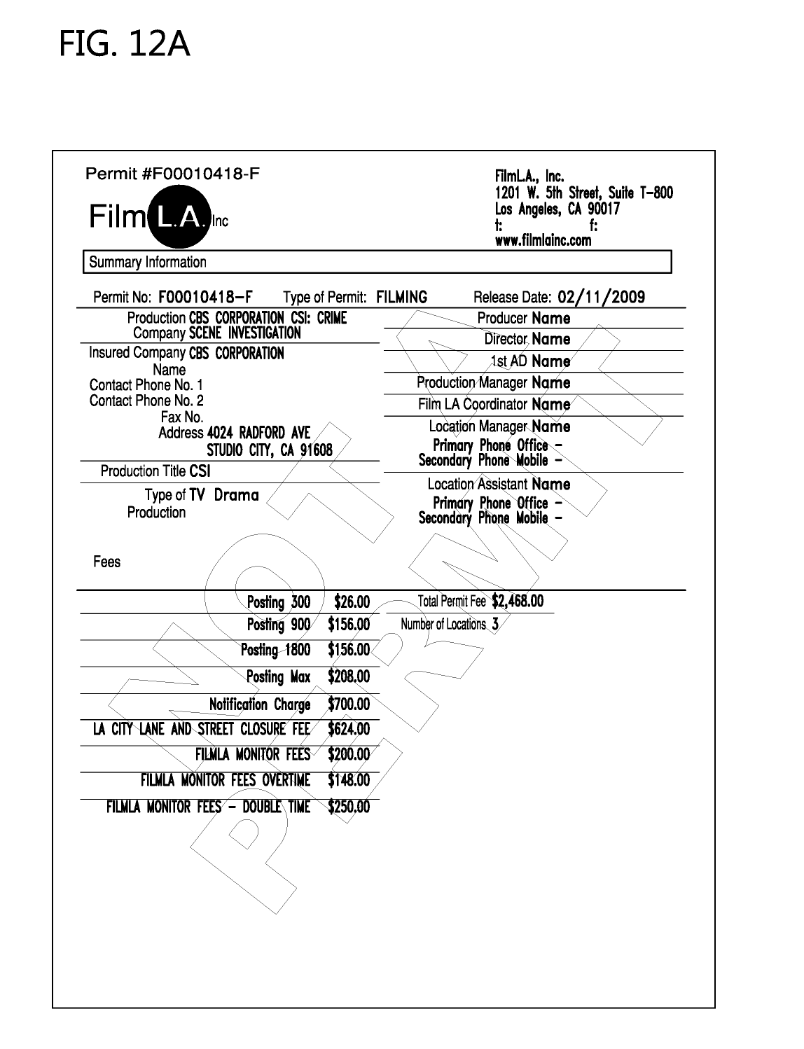

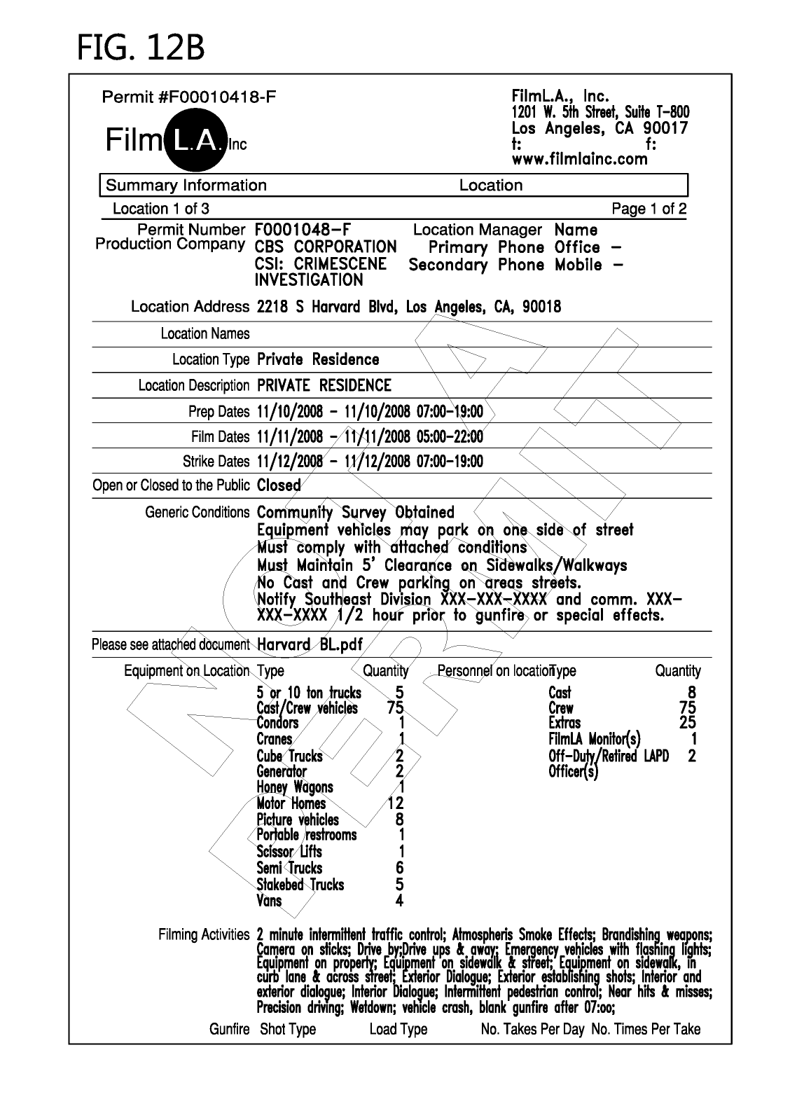

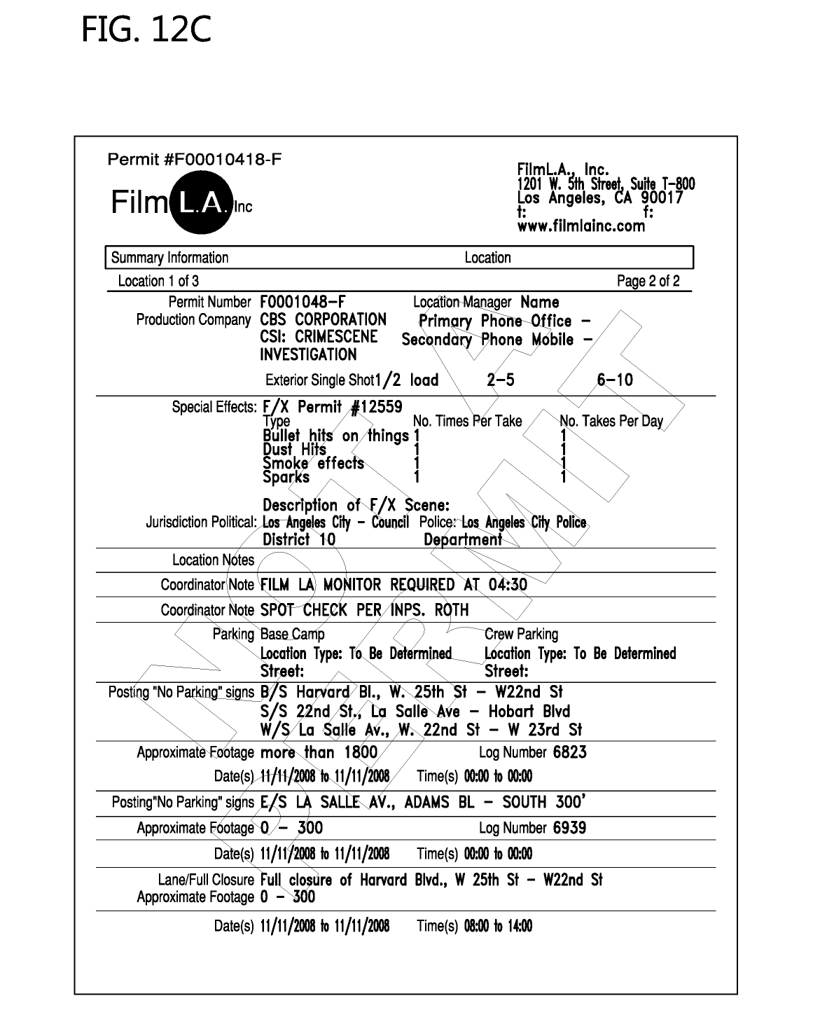

FIGS. 12A-C illustrate an example permit (this example is marked “not a permit” to indicate that it has not yet received final approval). Not all data fields need to contain data. Optionally, fewer or additional fields may be used. Some of the data may be provided by the applicant via the permit processing system (e.g., using a paper or electronic form, or verbally), and some data may be generated by the computer-based process system (e.g., the permit number) and/or may be entered by an administrator.

The example permit lists a uniquely assigned permit number, the permit type (e.g., filming), the release date, the production company name, the insured company name (which may be the same as the production company name), the insured company name contact information, the production title, the type of production (e.g., TV reality, feature film, sitcom, documentary, etc.), the levies (e.g., the permitting agency rider levy, posting levies, notification levies, street closure levies, filming agency monitoring levies, other levies, and the total levies), the producer, the director, the first assistant director, the production manager, the permitting agency coordinator, the location manager and associated contact information, the location assistant and associated contact information, and the number of locations associated with the permit.

In addition, the example permit includes location information, such as location address, location name, location type (e.g., private residence, public park, beach, commercial building, etc.), location information, and an indication as to whether or not the filming location is open or closed to the public. The permit also lists generic conditions related to the location and/or film category (e.g., were vehicles may or may not be parked, sidewalk clearness area, notification requirements, etc.).

Still further, the permit may list equipment on location (e.g., trucks, cast/crew vehicles, cranes, generators, motor homes, portable restrooms, vans). Still further, the permit may list personnel on location (cast, crew, spot check, etc.).

The permit may provide a summary of the filming activities (e.g., equipment on sidewalk only, interior/exterior filming, etc.). In addition, the permit may list the political jurisdiction (e.g., city, district, etc.), the police department that has jurisdiction over the filming/location, and the fire department that has jurisdiction over the filming/location.

Additionally, the permit may include location notes, such as identifying parking areas for the base camp and the crew.

Methods and processes described above may be embodied in, and fully automated via, software code modules executed by one or more general purpose computers or processors. The code modules may be stored in any type of computer-readable medium or other computer storage device. Some or all of the methods may alternatively be embodied in specialized computer hardware. Further, components and tasks described herein can be implemented as web services. Communications (e.g., notifications) discussed above can be performed using one or more of the following techniques and/or other techniques: email, web page, instant message, short messaging service (SMS) message, fax, hard copy correspondence, phone, or otherwise.

In addition, conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although this disclosure has been described in terms of certain example embodiments and applications, other embodiments and applications that are apparent to those of ordinary skill in the art, including embodiments and applications that do not provide all of the benefits described herein, are also within the scope of this disclosure. The scope of the inventions is defined only by the claims, which are intended to be construed without reference to any definitions that may be explicitly or implicitly included in any incorporated-by-reference materials.

What is claimed is:

1. A location-access control system, comprising:
a computing device;
a network interface;
non-transitory memory configured to store instructions that when executed by the computing device, are configured to cause the location-access system to perform operations comprising:
generate an interface configured to receive an identification of a desired location;
transmit to a remote terminal, using the network interface, the interface configured to receive an identification of a desired location;
receive over the network using the network interface, via the interface configured to receive an identification of a desired location, an identification of the desired location, the desired location associated with a latitude and longitude;
generate an interface configured to receive an identification of an event type to be associated with the desired location and corresponding date information;
transmit to the remote terminal, using the network interface, an interface configured to receive an identification of an event type to be associated with the desired location and corresponding date information;
receive over the network using the network interface, via the interface configured to receive an identification of an event type to be associated with the desired location and corresponding date information, the identification of the event type and the corresponding date information;
generate requests for location-related event data for a plurality of remote data stores for at least the identified location and the corresponding date information;
transmit over the network, using the network interface, the generated requests for location-related event data to the plurality of remote data stores;
receive and aggregate location-related event data from the plurality of remote data stores, the location-related event data comprising identifications of event types for a plurality of locations and corresponding location identifiers;
generate a request for a map from a remote mapping system using a map application programming interface, the request including a location specification, a zoom specification, and an overlay specification, the overlay specification comprising a specification for event indicators at corresponding event locations;
enable map tiles, generated by the remote mapping system in response to the map request, to be assembled and displayed on the remote terminal as map via a first user interface, the map including event indicators indicating event locations.

2. The location-access control system as defined in claim 1, wherein:
the desired location comprises a route, and wherein the location-access control system is further configured to utilize the map application programming interface to specify, in the overlay specification, a line color and a line stroke weight for line segments utilized to depict the route in the map,
the map depicts the route using at least a first line segment, having the specified line color and line stroke weight, with a first end point and a second end point, and the map is configured to enable a user to alter the identification of the desired location by dragging the first end point or the second end point, and
the first user interface comprises a hybrid map-calendar user interface that displays the map at the same time as a calendar interface, the calendar interface comprising a plurality of days, wherein a given calendar day displays information indicating locations of events scheduled for the given day and depicts, using icons, event types, and wherein the hybrid map-calendar user interface displays a summary generated by the location-access control system that includes location names, corresponding location types, and corresponding event types of location-based events scheduled for a selected day.

3. The location-access control system as defined in claim 1, wherein the desired location comprises a route, and wherein the location-access control system is further configured to utilize the map application programming interface to specify, in the overlay specification, a line color and a line stroke weight for line segments utilized to depict the route in the map.

4. The location-access control system as defined in claim 1, further comprising:
disked-based memory that stores a calendar database of location calendar records;
a calendar database firewall that monitors and controls access to the calendar database utilizing one or more predetermined rules,
wherein the calendar database is stored on a different disk partition or a different disk than an application that generates the interfaces transmitted to the remote terminal.

5. The location-access control system as defined in claim 1, wherein the desired location comprises a route and the map depicts the route using at least a first line segment with a first end point and a second end point, and the map is configured to enable a user to alter the identification of the desired location by dragging the first end point or the second end point.

6. The location-access control system as defined in claim 1, wherein the first user interface comprises a hybrid map-calendar user interface that displays the map at the same time as a calendar interface, the calendar interface comprising a plurality of days, wherein a given calendar day displays information indicating locations of events scheduled for the given day and depicts, using icons, event types, and wherein the hybrid map-calendar user interface displays a summary generated by the location-access control system that includes location names, corresponding location types, and corresponding event types of location-based events scheduled for a selected day.

7. The location-access control system as defined in claim 1, wherein the location-access control system is configured to identify a conflict with respect to a geo-fence associated with the requested location and a geo-fence of a location associated with a location of another event calendared on a same day and at least partly in response to identifying a conflict, transmit alerts to a plurality of devices using one or more communication channels.

8. A system, comprising:
a computing device;
a network interface;
non-transitory memory configured to store instructions that when executed by the computing device, are configured to cause the location-access system to perform operations comprising:
generate at least a first interface configured to:
receive an identification of a desired location,
receive an identification of an event type to be associated with the desired location and corresponding date information;
transmit to a remote terminal, using the network interface, the first interface configured to receive an identification of a desired location and an identification of an event type to be associated with the desired location and corresponding date information;
receive over the network using the network interface, via the first interface configured to receive an identification of a desired location and an identification of an event type to be associated with the desired location and corresponding date information, the identification of a desired location and the identification of an event type to be associated with the desired location and corresponding date information;
generate requests for location-related event data for a plurality of remote data stores for at least the identified location and the corresponding date information;
transmit over the network, using the network interface, the generated requests for location-related event data to the plurality of remote data stores;
receive location-related event data from the plurality of remote data stores, the location-related event data comprising identifications of event types for a plurality of locations and corresponding location identifiers;
generate a request for a map from a remote mapping system using a map application programming interface, the request including a location specification and an overlay specification, the overlay specification comprising a specification for event indicators at corresponding event locations;
enable a map to be displayed on the remote terminal via a second user interface, the map including event indicators indicating event locations.

9. The location-access control system as defined in claim 8, wherein:
the desired location comprises a route, and wherein the location-access control system is further configured to utilize the map application programming interface to specify, in the overlay specification, a line color and a line stroke weight for line segments utilized to depict the route in the map,
the map depicts the route using at least a first line segment, having the specified line color and line stroke weight, with a first end point and a second end point, and the map is configured to enable a user to alter the identification of the desired location by dragging the first end point or the second end point, and
the second user interface comprises a hybrid map-calendar user interface that displays the map at the same time as a calendar interface, the calendar interface comprising a plurality of days, wherein a given calendar day displays information indicating locations of events scheduled for the given day and depicts, using icons, event types, and wherein the hybrid map-calendar user interface displays a summary generated by the location-access control system that includes location names, corresponding location types, and corresponding event types of location-based events scheduled for a selected day.

10. The location-access control system as defined in claim 8, wherein the desired location comprises a route, and wherein the location-access control system is further configured to utilize the map application programming interface to specify, in the overlay specification, a line color and a line stroke weight for line segments utilized to depict the route in the map.

11. The location-access control system as defined in claim 8, further comprising:
disked-based memory that stores a calendar database of location calendar records;
a calendar database firewall that monitors and controls access to the calendar database,
wherein the calendar database is stored on a different disk partition or a different disk than an application that generates the interfaces transmitted to the remote terminal.

12. The location-access control system as defined in claim 8, wherein the desired location comprises a route and the map depicts the route using at least a first line segment with a first end point and a second end point, and the map is configured to enable a user to alter the identification of the desired location by dragging the first end point or the second end point.

13. The location-access control system as defined in claim 8, wherein the second user interface comprises a hybrid map-calendar user interface that displays the map at the same time as a calendar interface, the calendar interface comprising a plurality of days, wherein a given calendar day displays information indicating locations of events scheduled for the given day and depicts, using icons, event types, and wherein the hybrid map-calendar user interface displays a summary generated by the location-access control system that includes location names, corresponding location types, and corresponding event types of location-based events scheduled for a selected day.

14. The location-access control system as defined in claim 8, wherein the location-access control system is configured to identify a conflict with respect to a geo-fence associated with the requested location and a geo-fence of a location associated with a location of another event calendared on a same day and at least partly in response to identifying a conflict, transmit alerts to a plurality of devices using one or more communication channels.

15. A computer-implemented method, comprising:
generating, by a computer system comprising at least a computing device, at least a first interface configured to:
receive an identification of a desired location,
receive an identification of an event type to be associated with the desired location and corresponding date information;
transmitting to a remote terminal, using a network interface, the first interface configured to receive an identification of a desired location and an identification of an event type to be associated with the desired location and corresponding date information;
receiving over the network using the network interface, via the first interface configured to receive an identification of a desired location and an identification of an event type to be associated with the desired location and corresponding date information, the identification of a desired location and the identification of an event type to be associated with the desired location and corresponding date information;
generating requests for location-related event data for a plurality of remote data stores for at least the identified location and the corresponding date information;
transmitting over the network, using the network interface, the generated requests for location-related event data to the plurality of remote data stores;
receiving location-related event data from the plurality of remote data stores, the location-related event data comprising identifications of event types for a plurality of locations and corresponding location identifiers;
generating a request for a map from a remote mapping system using a map application programming interface, the request including a location specification and an overlay specification, the overlay specification comprising a specification for event indicators at corresponding event locations;
causing, at least in part, a map to be displayed on the remote terminal via a second user interface, the map including event indicators indicating event locations.

16. The method as defined in claim 15, wherein:
the desired location comprises a route, and the method further comprising:
utilizing the map application programming interface to specify, in the overlay specification, a line color and a line stroke weight for line segments utilized to depict the route in the map,
wherein the map depicts the route using at least a first line segment, having the specified line color and line stroke weight, with a first end point and a second end point, and the map is configured to enable a user to alter the identification of the desired location by dragging the first end point or the second end point, and
and wherein causing, at least in part, the map to be displayed on the remote terminal via the second user interface further comprises causing the map to be displayed in a hybrid map-calendar user interface that displays the map at the same time as a calendar interface, the calendar interface comprising a plurality of days, wherein a given calendar day displays information indicating locations of events scheduled for the given day and depicts, using icons, event types, and wherein the hybrid map-calendar user interface displays a summary generated by the location-access control system that includes location names, corresponding location types, and corresponding event types of location-based events scheduled for a selected day.

17. The method as defined in claim 15, wherein the desired location comprises a route, and the method further comprising utilizing the map application programming interface to specify, in the overlay specification, a line color and a line stroke weight for line segments utilized to depict the route in the map.

18. The method as defined in claim 15, the method further comprising:
utilizing disked-based memory to store a calendar database of location calendar records on a different disk partition or a different disk than an application that generates user interfaces transmitted to the remote terminal; and
monitoring and controlling access to the calendar database using a calendar database firewall.

19. The method as defined in claim 15, wherein the desired location comprises a route and the map depicts the route using at least a first line segment with a first end point and a second end point, and the map is configured to enable a user to alter the identification of the desired location by dragging the first end point or the second end point.

20. The method as defined in claim 15, wherein the second user interface comprises a hybrid map-calendar user interface that displays the map at the same time as a calendar interface, the calendar interface comprising a plurality of days, wherein a given calendar day displays information indicating locations of events scheduled for the given day and depicts, using icons, event types, and wherein the hybrid map-calendar user interface displays a summary generated by the location-access control system that includes location names, corresponding location types, and corresponding event types of location-based events scheduled for a selected day.
